(19) United States
(12) Patent Application Publication
(10) Pub. No.: US 2017/0344886 A1
(43) Pub. Date: Nov. 30, 2017

(54) Knowledge Management System also known as Computer Machinery for Knowledge Management

(71) Applicant: Tse-Kin Tong, Buffalo, NY (US)

(72) Inventor: Tse-Kin Tong, Buffalo, NY (US)

(21) Appl. No.: 15/163,727

(22) Filed: May 25, 2016

(51) Int. Cl. G06N 5/02

(52) U.S. Cl. CPC G06N 5/022

(57) ABSTRACT

This Knowledge Management (hereafter referred as KM) System provides a unified portal and platform for the following purposes:
A. Capture, organize, maintain and retrieve knowledge.
B. Provide features and functions for knowledge specification, authentication, classification, storage, validation, version control, date and time stamping, linkage and attachment etc.
C. Enable authors to publish their knowledge on Internet, Intranet, or other similar platform.
D. Provide functions to extract knowledge from, or simply link to, articles or other forms of documentation.
E. Open to the targeted user groups to add on their knowledge.
F. Enable appointed librarian to catalogue knowledge.
G. Allow knowledge seeker to find and learn knowledge.

Basic designed functions include the following:
Document various relationships (both natural and artificial) among Subjects, Perspective, and Knowledge. In this aspect, this KM System functions as an organizational tool.
Document brief presentation to promote preliminary or high level understanding of each piece of knowledge. Such documentation will be Subject and Perspective oriented, including brief explanation, similarities, alternatives, analogies, contraries, oppositions etc. In this aspect, this KM System functions as an abstraction tool.
Include linkages to more detailed information for in-depth appreciation and understanding of each piece of knowledge. In this aspect, this KM System functions as an integration tool.

There will be three different versions of this KM System. One version is open to the public to manage public knowledge. Another version is for organizations and business sectors to manage organizational or professional knowledge. The third version is for education/training institutes to store and transfer knowledge.

In general, this KM System is designed to bring the following benefits to the users and stakeholders:
Capture, catalogue, and integrate information to form knowledge
Provide a platform for easy knowledge publication and research
Provide an integration point for all information providers
Enhance collaboration that is knowledge based
Provide a background and platform for Knowledge Extension and ultimately Intelligence Management

This KM System ultimately functions as a universal and unified portal to all knowledge documented in the hosting network and connected inter-networks. The overall design is to ensure that such a portal is efficient for both knowledge authors and seekers. Applications will be developed based on this KM System and some are included in this document.

### CONCEPTUAL DESIGN

### Overall Concept

Data are numbers or narrations that may not have clear meaning by themselves. Further explanation turns data into information. Information is often referred to by a name or term that represents a real life Object, or a concept.

Knowledge represents the ability to retrieve a piece of information that explains an Object for its meaning, usage in real life, or for decision making This can be achieved by describing how a piece of information may be related to specific purposes, or by positioning that piece of information in related Subject Space.

Formally speaking, knowledge is information about an Object within the scope of a Subject. Both Object and Subject may be real/physical or imaginary/conceptual. The Object may carry a name that represents the common label of that piece of information.

The transformation from information to knowledge implies usability and applicability of that information, and is dependent on the following:
1. Ability to find the related information to solve a problem, to improve the decision-making process in solving a problem, or just to enhance the knowledge further;
2. Conciseness and preciseness of the related information.

Ability to find the related information is improved by tracking information by the problem areas, related issues etc.; or formally speaking, by various Subjects or topics. A complete Subject definition is a multi-dimensional method to position and organize information Objects for efficient and effective referral and retrieval.

Preciseness of information may be improved by being accurate and specific in its content. Conciseness of information is improved by breaking up large chunk of information into smaller pieces. In doing so, a piece of information about an Object may be subdivided into multiple subsets, each related to some particular attributes of the Object

Formally speaking, knowledge of an Object consists of attribute values; numerical or descriptive. Generalization of the attributes are attribute types that point to further fine tuning of the related Subject Space and more precisely position the Object in the Subject Space.

Presentation of information related to an Object can be in more than one form; e.g., words, diagrams, photos, video etc. These can be standardized as several presentation dimensions of any Objects and treated as alternative or complementary presentations of the related information.

Objects and Subjects are double roles of an information piece depending on its relationship with other information in addressing an issue, a problem, a decision, or a concept. A Subject is also an Object as there is knowledge related to its meaning. An Object is also a Subject as it has internal Subject Space defined by its attribute types.

### Design Objectives

This KM System permits an author to capture a piece of information about an Object referred by its name. Often, a Knowledge Object may be further broken down into multiple levels of components or parts. This is structuring of that piece of knowledge and refinement of knowledge by its application areas. With a good structure, knowledge is scalable information. Knowledge seekers may zoom out for abstraction and zoom in for details.

Knowledge is application of information to make decision and to solve problem Usability of a Knowledge Object depends heavily on the effectiveness of retrieving the contained information whenever it is needed, and knowing where and how to apply that piece of information. Applicability of a piece of knowledge requires positioning that Knowledge Object properly in the Subject Domain that defines its applications.

This KM System provides machineries to define both Objects and Subjects, and the relationship among them, so as to greatly enhance usability of the stored information. The contents about Subjects, Objects, the relationships among them should be taken together to form a Knowledge Base. This Knowledge Base, plus functions and features described in this document, constitute a Knowledge Management System.

The usability of a KM System, on top of reliable information, depends mainly on the following:
How efficiently a potential user can find and understand the required information?
How effectively a potential user can apply the information to achieve the purpose of finding that information?Algorithms are described in the various design sections in this document, including the capturing and structuring the content, retrieval of the content, and development of application to make use of the content.

This KM System provides the following high level functions for users to meet the above objectives:
Find the related knowledge (Objects) by navigating through the Subject Structure
Examine the application areas fully (related Subject Structure) and select the related Subject Space and Knowledge Objects
Quickly capture an overview for broad understanding of the knowledge (front page)
Perform in-depth and detailed research when necessary (embedded connectors)

The required piece of information may be directly retrieved if the user knows the name (or part of the name) of that Object. Alternatively, a well-defined Subject Space will help users to efficiently and effectively focus at the related application area, and then select from a list of related Objects. The generic and effective reliance is the proper filing and indexing of the Knowledge Objects by a good Subject Structure, with efficient search functions by Subject Names. The related Subjects of a Knowledge Object represent the application areas of that piece of information, turning a piece of useless information into usable knowledge. A user who wants to find knowledge about a Subject but does not know the Object Name may still be able to find the required knowledge by search through all Objects that are related to the selected Subject Space.

### Design Principles and Outlines

Existing information and knowledge libraries consist of mainly large information packages (e.g. books, magazines and documents) labeled by various topics and titles, and catalogued under one or multiple Subjects. One who looks for knowledge often needs to search and research in order to extract information to form a piece of knowledge.

This KM System builds a library of much smaller and structured packages of information well positioned in a Subject Space that is defined and sub-defined by multiple levels of Subject Dimensions. User will be able to examine the breakdown of both Subjects and Objects. User may trace from Subjects to Objects or from Objects to Subjects, in order to gather enough required knowledge.

A Subject is defined by one or multiple dimensions. Each dimension may be further broken down into, or defined by, its sub-dimensions. Dimensions of a Subject may or may not be normalized (i.e. independent of one another).

Each dimension definition is also a Knowledge Object by itself and may be further explained likewise. In fact, the functional role as Object or Subject depends on the situation and purpose, and should be defined likewise. Knowledge Object in one case may be Knowledge Subject in another case, and vice versa.

Knowledge Objects taken together are interconnected as many-to-many relationship. This relationship is realized, explicitly through Object Content and Object Break-down, and implicitly through Subject Structure that is a gradual and controlled break-down by its dimensions (normalized or otherwise).

Technically speaking, this KM System includes Objects and their content, and various types of relationship among those Objects, including the following:
Relationships that break down an Object into components
Relationships that represent sub-typing and super-typing of Objects
Relationships that are multi-dimensional break-down of the Subject domain
Relationships between the Objects and Subjects

The design principles of this KM System include the following:
A front-ending, controlled and authorized System that provides some kind of summarized and abstracted content of information and knowledge.
A connection point for integration and interfacing of all information and knowledge systems.
Enable information of an Object to be classified in a complete Subject Structure that is multi-dimensional and multi-layered.
Permit many-to-many relationships among Knowledge Objects and Subjects.

### Analysis by Subject Dimensions

Knowledge is the result of analysis. Analysis cannot be done in a vacuum. It is done with respect of something, about something, or relative to something Analysis can only be done in an analytical space that is created with dimensions. These dimensions are called Subjects. Many Subjects at high level are commonly referred to as a single word, or a phrase. Each of these words and phrases represents a totality of its breakdowns into components or aspects. These components or aspects are multi-dimensional spaces under that higher level Subject. Each dimension may be further broken down into sub-dimensions.

This KM System includes functions to capture or define Subjects as multiple levels with multiple dimensions at each level. In theory, the dimensional definition of a Subject is most simple if normalized, but usually more efficient and effective if otherwise. In fact, multiple alternative break-down of non-normalized dimensions are often a lot more usable. There are, however, academic and professional bodies that may formally design normalized breakdown whenever feasible. Academic Subject breakdown for scholars may co-exist with informal or common breakdown for laymen.

This method of defining Subject as of multiple dimensions is a major advantage compared to the traditional library catalogue, or tagging electronic version of information library. It is much more complete and precise, permitting much more efficient retrieval of relevant knowledge.

This KM System allows Subject Editors, or Knowledge Librarians, to define and manage a standard set of Subject Dimensions. Knowledge authors may link their Knowledge Objects to the already defined Subject Dimensions. Alternatively, Knowledge authors may propose new dimensions based on documented attributes of the Knowledge Object, to be approved by the related Subject Editor. This is an essential design feature for collaboration between authors and editors. Subject Space, as defined by Subject Dimensions, is also one kind of knowledge, and hence may evolve over time like any knowledge.

Once defined, this multi-level structure of Subject Space may be displayed in more than one way on the screen. Display formats may depend on the user devices, interfacing software, user preferences, and related perspectives.

The Subject Editors or Knowledge Librarians define and manage a set of standard Subject Space definition as a standard catalogue of all knowledge. Tools will be included to allow knowledge seekers to enter Subject Dimensions in other structures. This KM System will be able to accept these variations and still search out related Knowledge Objects.

All Subject Structures represent refinement of a higher level Subject, so that related knowledge may point to its related application area. This pointing of application area can approach from more than one direction, representing multiple ways to break down a Subject. This KM System will allow users to narrow down Subject areas by naming the dimensions in any order. This KM System will map all specifications to the Subject structures already defined in this KM System, and find the related knowledge.

### Information Encapsulated in Objects

This KM System includes functions that permit an Author to input/capture a piece of Knowledge as an Integral unit of Information and store in the computer as a single Knowledge Object. This Knowledge Object is identified by a name that is a word or a phrase, but may have a number of alternative Names or Terms.

Content of each Unit of Information, or Knowledge Object, includes a front page that present the Knowledge briefly with Abstraction and other explanations. This explanation may include concepts such as similarity, analogy and contrary, in order to fully explain the Knowledge.

The front page also include connectors to other pages that further explain the Knowledge, with detailed presentations, illustrations, best practices, counter-points, opposite views, recommendations for learners etc.

There will be connectors to share opinions and ideas including discussion forum, posting of experiences, lessons learned, questions and answers etc.

There will be connectors to multi-media directories of related knowledge experts, and product/service providers.

While Knowledge Object may be stored without relating it to any Subject, this is only considered as an interim step. In fact, the more productive method to produce Knowledge Object is to find the proper location in the Subject Space first before creating a new Knowledge Object, so that the Object is properly catalogued and hence usable right after its creation.

A Knowledge Objects that has not been related to any Subject imply that it is just a piece of information floating among various Knowledge Spaces. This information is probably useless until subsequent procedures have been executed to link it to the proper Subject Spaces.

When Authors are ready to document Knowledge in the most efficient way, one important design of this mechanism will allow Authors to structurally break down a Knowledge Object into multiple levels of components, with each component part addressing one attribute type. The attributes of a Knowledge Object can be numerical or descriptive.

### Position Knowledge Objects in Subject Space

This KM System includes functions that permit a Knowledge Author to relate a Knowledge Object to one or multiple Subjects that are defined by its dimensions. This Subject may be an existing one, modified from an existing Subject, or a brand new one. This KM System allows general authors to create new Subject as a proposal, and allows Subject Editors to authorize Subject Structure as an on-going and evolving process.

This KM System provides functions for a Knowledge Author to start from any name of a Subject Dimension. From this starting point, an author may navigate through the existing Subject Structure until finding the most appropriate one with, or without, further modifications. These features are essential for the effectiveness of this KM System and will include the following:
Search and find all related Subjects based on one or multiple words or phrases.
Display graphically the related Subject Structure showing all dimensions and sub-dimensions.
Allow an Author to trim down and modify the displayed Subject Space by selecting and modifying the Subject Dimensions and sub-dimensions.
Capture and store the relationship between the Knowledge Object and the finalized Subject Structure.
If new Subject Dimension has been included, the new Subject will be sent to the related Subject Editor for approval.

The information stored in a Knowledge Object; and the Object well positioned in the Subject Space, are two important factors. These two factors enrich the context, facilitate better understanding, and enhance the usefulness (application) of the information.

The definition of Subject Space and the positioning of Knowledge Objects within the Subject Space represent macro level management of Knowledge. It allows users to find the required knowledge in an efficient way. It also provides alternative, or in some cases, competitive knowledge of the same Subject; or alternative solutions to the same problem.

### The Vision

Explosion of Knowledge has created a plentiful universe of information. People are having difficulties in looking for required Knowledge to answer their questions, enlighten their doubts, and solve their problems. Subject Definitions and non-normalized dimensional breakdowns function like stars in space. These stars guide people to zoom in and focus at a much smaller area in the Knowledge Space, until the required Knowledge Objects have been identified and fully examined.

### Knowledge for Computing Machineries

Knowledge Objects include those that are understandable by machineries instead of humans. This KM System goes beyond human knowledge. It includes computer software, computer input parameters, and processing control options that govern the software execution.

### Logical Design—Subject Structure

### Design Objectives

Subject defines the relevancy of information to form Knowledge. This needs to be done properly by experts in the related Knowledge, Subject Area Experts. The break-down of Subjects into Sub-subjects should be based on perspective of users with various levels of knowledge in that Subject.

### Academic Structure

Academic Structure represents how a Subject is to be taught and learnt, hence very useful for teachers, students, researchers, and educated users.

### Professional Structure

Professional Structure is based on best business practices and professional standards. This kind of breakdown will be very useful for the business world and as standards for both product/service providers and receivers.

### Popular Structure

This is the laymen's understanding of the Subject. The structure may be confusing to some, but yet represent how general public may look into the Subject to find information.

One way to build this structure is based on popular search paths for knowledge. This KM System will track searching from users and identify the popular search paths of each Knowledge Object. Subject Editors may then create or revise popular structure accordingly.

### Combined Structure

When applicable, it is desirable to include all types of structures below a high level Subject. Each structure is designed for the efficiency of a different group of users.

### Subject is also an Object

Any Subject at any level is also a Knowledge Object with abstracted information representing the totality of all related Knowledge Object. Following this concept, the next section on Object Refinement may also be the way to break down a Subject.

### Logical Design—Knowledge Refinement

### Design Objectives

A Knowledge Object may be broken down into finer component Objects, or attributes. As each component Object is being defined, its related Subject dimension may also be refined by sub-dimensions. Attributes of an Object are values assumed under attribute types. In other words, both Object and Subject may be decomposed together. The following are some of the typical decomposition of Knowledge Object.

### Conceptual Breakdown

Some knowledge is conceptual. This KM System allows a Knowledge Author to break down knowledge by specialization or conceptual refinement. In this breakdown, all the components further explain a special situation, bias, or variation of a concept. This implies no sequence among the components.

### Structural Breakdown

Some knowledge is structural. This KM System allows a Knowledge Author to break down knowledge with structural components, e.g., machine and parts. This requires quantitative and/or qualitative specifications of components. Structure breakdown is Subject to logical operands AND, exclusive OR, inclusive OR, Options etc.

### Procedural Breakdown

Some knowledge is procedural. This KM System allows a Knowledge Author to break down knowledge as Procedures. This means that the attributes of a Knowledge Object are sequenced. Example: cooking steps, operational procedures. This requires specification of sequence, quantity and quality of components.

### Attribute Breakdown

In general, a Knowledge Object may contain multiple attributes of that Object. Each attribute value represents a certain position within that related Attribute Type. When all the attribute types are taken together, it represents the relative position of that Object within the space created by all related attribute types. Identifying the attribute types related to a Knowledge Object, therefore, helps to fine tune the related Subject Domain.

It is important not to overdo this kind of breakdown. Staying at the knowledge level implies that each entity must be usable with a purpose. This may be a judgment call and hence needs to be controlled by authors.

### Logical Design—Roles and Relationship Computing

### Allow Multiple Occurrences of Objects and Subjects with the Same Name

There will be multiple occurrences of both Objects and Subjects with the same name but different meaning (content). These multiple occurrences represent different positions in the Subject Space. Uniqueness of Subjects with the same name is obtained by its relationships with other Subjects. Uniqueness of Objects with the same name is obtained by its relationships with different sets of Subjects.

### Subject and Object as Dual Roles

By definition, any Subject is also a Knowledge Object within the Subject Space of “Subjects”, and will contain explanation about that Subject.

The name of a Knowledge Object may also imply a potential Subject. The attribute types of a Knowledge Object point to an analytical space or Subject Structure of that Knowledge Object, or a group of similar Objects. A Knowledge Object may easily form a Subject Dimension by another Knowledge Object.

The design of this KM System treats both Subjects and Objects as dual roles of a piece of information. On that basis, this KM System stores and connects information for efficient usages by knowledge authors and knowledge seekers.

When a Subject is defined or edited in the system, not only the Subject structure will be created and maintained, a Knowledge Object Record will be created at the same time. On the other hand, when a Knowledge Object is defined or edited in the system, the Subject Space will also be updated with the applicable information.

In simple terms, roles of Subjects and Objects include the following:
Subjects define the questions; Objects provide the answers.
Subjects create knowledge space; Objects contain the knowledge.
Subjects classify the knowledge; Objects identify the knowledge.
Subjects identify problems; Objects provide solutions.
Subjects locate the knowledge; Objects store the knowledge.

For Subject drill down, one may pick multiple choices as dimensional drill down to focus at more precise Subject Area. For Object selection, normally multiple Objects within the same selected Subject Domain represent alternative choices (single or multiple) as answers, solutions or relevant knowledge.

### Subject and Object with Alternative Names

It is possible that several alternative terms/words imply the same Subject or Object. This KM System allows alternative names with the same meaning.

### DESCRIPTION OF DRAWINGS: LOGICAL DESIGN—RELATIONSHIP AMONG SUBJECTS AND OBJECTS

FIG. 1: Dual roles of information entity, as Subject and as Object

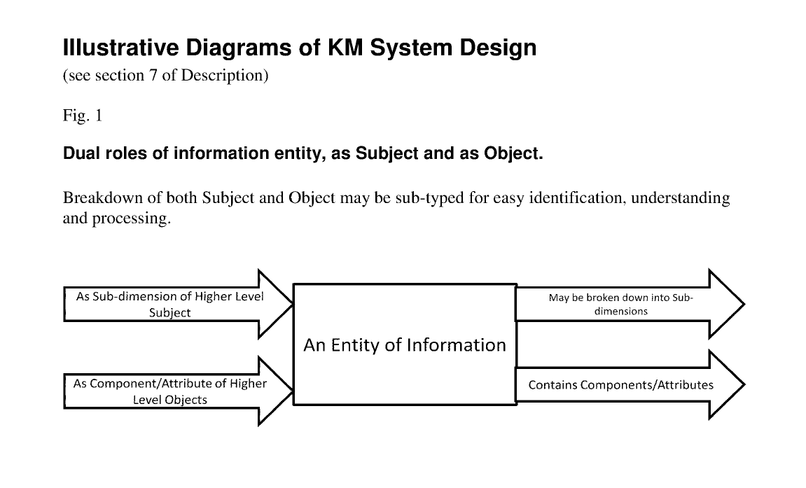

An entity can be both a Subject and an Object with dual roles. Breakdown of both Subject and Object may be sub-typed for easy identification, understanding and processing. FIG. 1 illustrates such a situation

FIG. 2: Object broken down into components, or contains attributes

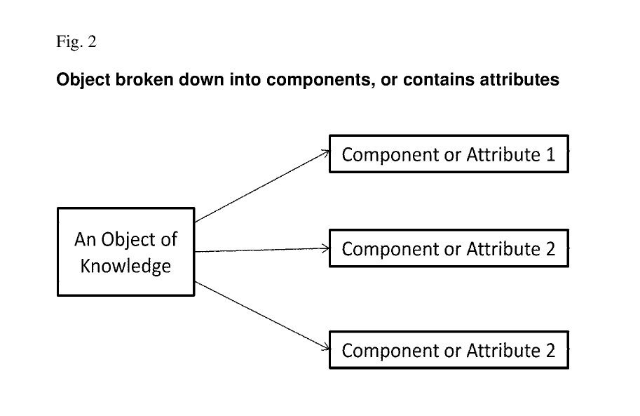

An Object may have multiple attributes hence may be broken down into components as illustrated in FIG. 2.

FIG. 3: Subject-to-Subject relationships as “many-to-many bidirectional” relationships

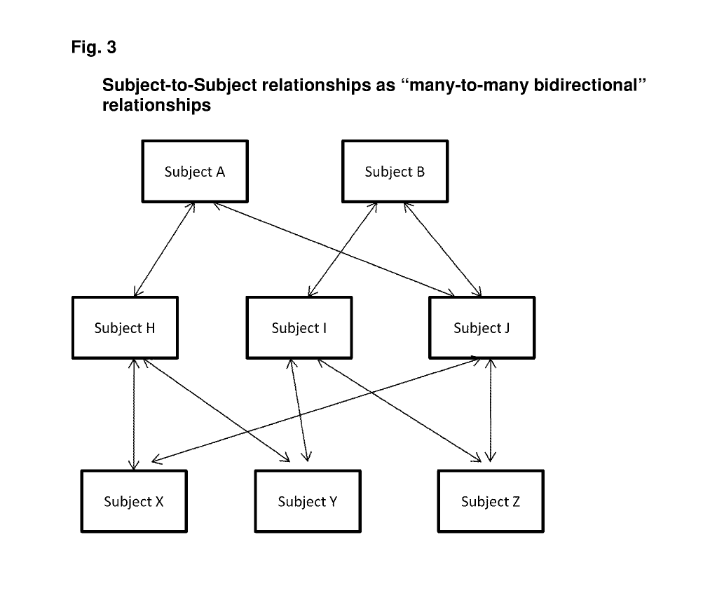

Relationships among Subjects are many-to-many as shown by FIG. 3. Knowledge users may go up and down to zoom in or zoom out the subject domain.

FIG. 4: Subject to Objects as “many-to-many bidirectional” relationships

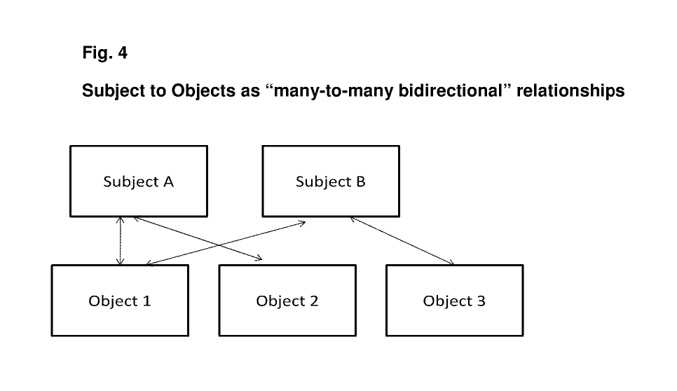

Relationships between Subjects and Objects are many-to-many as illustrated by FIG. 4. Knowledge users may go to all related Objects from a Subject, or find out what Subjects and Object is related to.

FIG. 5: Logical Design—Layered Architecture Scheme

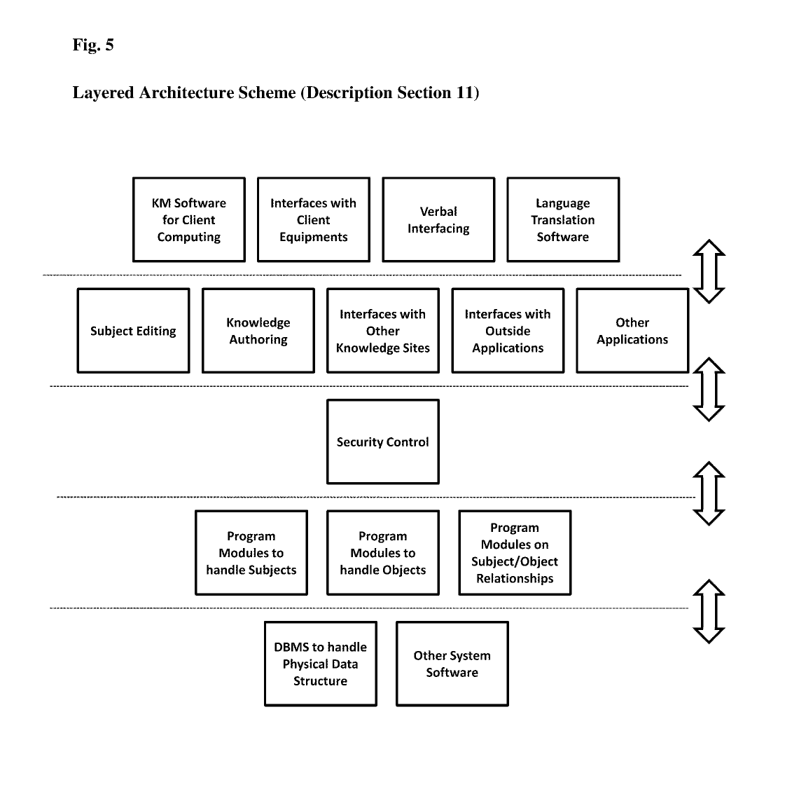

A layered architecture provides flexibility in design, maintenance, enhancement, and is flexible for distributed processing among hardware processors. The following diagram illustrates the logical structure of some software modules. This is illustrated in FIG. 5.

### LOGICAL DESIGN—KNOWLEDGE AUTHORING

### Design Objectives

All authoring described here may include multi-media content.

Traditional authoring is writing and publishing a book with a title, table of contents, text and index. This KM System provides similar method for electronic authoring, and in addition, several new methods to author knowledge and ideas.

Under the concept of this KM System, a book is a Knowledge Object within the Subject Space of All Books. The Book Title is the name of the book Object. The Table of Content is one way to break down the Book as an Object into components, and each component may be further broken down into sub-components, forming a hierarchy in the table of content. The index may be structured into a hierarchy of multiple levels as well, representing another dimensional breakdown of the book.

As new methods of authoring, an Author can use the functions in Section 2 to document knowledge. In addition, this KM System includes design for Authors to present a group of knowledge related to a Subject in a structured manner. This is grouping of knowledge with presentation in mind, and to satisfy a particular purpose, i.e., to present a perspective to the readers. A perspective represents the view of a Knowledge Author and is a special kind of Subject Definition presented by the Author.

This KM System allows a Knowledge Author to organize and present knowledge under multiple and alternative perspectives as explained in the following sections. Each perspective represents one set of sub-dimensioning of the Book as an Object.

For the process of writing, this KM System allows Authors to write in either top-down or bottom-up method.

For bottom up method of writing, an Author can document Knowledge Objects over a period of time, with or without grouping these Objects together. Then the Author may decide to group these Objects together to form some kind of presentations or perspectives, allowing knowledge seekers to go through this group of knowledge in a structured manner.

For top-down writing, the Author may have a specific perspective on one or multiple Objects. The author proceeds to define and fine tune the Perspective as dimensions of a Subject Space for general reading and understanding. Details are then Knowledge Objects linked together by that Perspective. The linkages form a table of contents. After writing, the author may re-arrange or re-sequence the content in additional ways, to form more than one perspective. These perspectives represent different presentations for different groups of readers who may want to pick up knowledge in different sequences.

### Present Knowledge with Multiple Perspectives

This KM System provides features and functions for Knowledge Authors to establish various perspectives of a selected Subject. This creates different structures, table of content, or presentation sequence of the Knowledge Objects, for better understanding and utilization by the readers.

Multiple perspectives provide a major advancement compared to traditional book-writing. Traditional books may include instructions at the beginning recommending different reading sequences to readers with different background and objectives. This KM System will allow much more dynamic mechanisms for readers. Readers may select from multiple perspectives and pick up the required knowledge accordingly.

Some perspectives are explained further in the following sections.

### Structural Perspective

For Knowledge Authoring and as part of this KM System, a Knowledge Object is normally structured as multiple levels of information. Each level is a summary or abstraction, of the lower level. A lower level contains the more detailed information as structural breakdown of the higher level information. Specifically, when a level includes multiple attributes of that Knowledge Object, its content may be divided up into information pieces, each related to one attribute only. This is sub-typing of a higher level Object into lower level Objects.

This KM System provides functions and tools to facilitate authoring by structural perspective. This can be based on already defined Subject structure in this KM System, or by the newly defined attribute types within the Knowledge Object.

### Academic Perspective

The Academic Perspective represents the recognized method to learn the content of the related Subject. It is presumably how most academic authors present that Subject as a text book, or to structure the related knowledge for formal presentation to learners.

For well-developed knowledge, this is the baseline of all perspectives. It can be the first perspective in authoring that Subject. However, this KM System permits knowledge to be captured or presented by other perspectives for specific purposes.

### Innovative Perspective

This is the unlimited variations on presentation of a Subject similar to multiple books published on the same Subject.

### Recording and/or Documentation Perspective

This is normally an interim structure to build up the documentation of a Subject, before turning this collection of knowledge into formal knowledge. Historical perspective is an example of this perspective.

### Training and/or Skill Transfer Perspective

This perspective is a recommended learning sequence of the related knowledge, easier than just going through the Academic Perspective. It is also possible to create multiple training perspectives by the background of the learners.

### User or Reference Perspective

This is normally an evolving structure that a learner/student establishes while picking up the knowledge of a Subject. The scope of this perspective is normally partial, compared to the academic view, and may be slightly different from the Training Perspective due to different learning inclinations among learners.

### Perspectives to be classified by related Subjects

A perspective may be classified by one or multiple Subjects at a higher level. This KM System allows a Knowledge Author to link perspectives to one or multiple Subject structures.

### More dynamic Table of Content as the next level below each Perspective

A perspective is a special type of Subject. A perspective is further broken down as table of content which forms a lower level of Subject. This KM System allows different Table of Content for different Perspective. This Table of Content will form the next level of Subjects under each Perspective and can be multiple levels and multi-dimensional.

### Logical Design—Knowledge Based Applications

### Design Objectives

This KM System should provide a platform for knowledge based computer applications. Users should require much less training and pre-conceived knowledge to use computer applications. The following describes the generic logical structure and algorithm of knowledge based computer applications.

### Application and Situation as Subjects

Overall Application Name is the high level Subject, broken down into a number of situations where the application may be used.

### Usability as Knowledge Objects

Knowledge Objects include those for humans and for machineries. Self-learning Program and Help Functions are Subject dimensions intersecting with Functions and Features of the Application. Knowledge Objects may contain training materials, help information, business procedures, triggers of processing functions, machine readable knowledge etc.

An application user may approach the application by going through the Subject Structure of functionality to understand the application. The user can then execute the related procedures to trigger the necessary computer processing.

### Functionality as Knowledge Objects

At the top level there are Knowledge Objects that document the purpose of the application. The next level of knowledge documents various situations of users. Each situation may include a number of intended usages of the Subject application. Each usage includes a number of procedures for the users to perform.

When desirable, the application will ask users to answer questions that would capture and verify the situation of a user. Based on the captured situation, different application procedures and implied application functions will be executed.

### Procedures as Knowledge Objects

Optionally, an application may include procedural knowledge to guide the users to complete related procedures in order to properly utilize the application. Automated processing may be triggered at various points when procedures are being followed.

### Data Capturing and Audit Trail as Knowledge Objects

As processing is being done by the application, new Knowledge Objects will be created to capture data and record other audit trail data as permanent records for future reference.

### Logical Design—Security Control

### Design Principles

This KM System will have the core portion residing in a Web Site (Internet or Intranet). There may also be user functions and applications in personal computers. Design of security control for this KM System includes consideration of quality control, designated user authority, nature of knowledge and legal requirements.

In addition, the following principles have been included in design consideration:
Security control in general belongs to the Subject owner or designated person
Security within the personal computer is under the control of the computer owner.
Security control during the authoring process is under the control of the author.

For public KM System, security control is limited to only maintenance functions, as all Subjects and Objects are open to the public. For proprietary KM System, full scale security control may be required.

Host of this KM System will have the choice of using the built-in security control of this KM System, using another security management system, or any other pre-defined combination.

### Subject and Object Based Security

Security control schemes may parallel the structure of Knowledge Subjects and Objects. Both Subject Space and Knowledge Objects may cany a security level. Different levels may be assigned for reading and maintenance functions.

Lowest level of security implies open to the public. Top level of security implies only explicitly allowed users can perform the function on that related Subject Space, or a related Knowledge Object. Lower level Subjects, by default, cany the same security level unless explicitly defined with a higher level of security. This is a scalable security control scheme embedded into the knowledge content.

### User Based Security

Security may be imposed by user identification. For security control within the knowledge database, any user inquiry will go through a security control middle ware to clear its security level authority. User with the right security level authority will then be able to perform all functions allowed for that security level.

Highest level of security control will be accessibility by explicit user identification.

### Author Based Security

The control scheme of author based security is mainly at two levels, by Subject Editors and Object Authors. High level Subjects are assigned to Subject Editors who have the authority to work on all Objects related to the authorized Subjects that have been published.

Before publication, control of related Knowledge Objects is totally within the control of the Authors. Authors need not allow anyone else to read or write those Objects. Subject Editors may delete those Objects but cannot view or change the content of those not yet published Objects.

When Knowledge Objects are ready for publication, the Author will submit those Objects to the related Subject Editor, including the related authority. Subject Editor can then make further changes before publication. After publication, the Subject Editor will retain full control of those published Objects.

Application processing function will create Knowledge Objects and position those Objects in the desired Subject Space with implied security, unless specified otherwise.

### Physical Design—Interface with Available Data Base Management Software (DBMS) Technologies

### Design Objectives

The logical database structure of this KM System includes Object Oriented, Relational, Network, and Hierarchical Structures. Mapping from business model to technology model may be done through the logical model of DBMS. The mapping from logical model to physical model may be done in accordance to the deployed DBMS technology.

### Similarity with Various Models

Knowledge as Objects is consistent with the Object Orientated Model.

Subjects and Objects are entities hence suit well to Relational Model and RDBMS. Relational language is appropriate for the management of the various types of many-to-many relationships among Subjects and Objects.

Breakdown of both Subjects and Objects are hierarchical structure, and occasionally with multiple parents.

Logically, the star schema in Data Warehousing and Decision Support Systems is similar to the non-normalized dimensional structure of Subjects.

### Implementation with Existing DBMS Technologies

Without getting into too much complexity by including multiple DBMS, this KM System may be implemented with the following options that include only one or two DBMS.

Option 1—use RDBMS only.

Option 2—use both ODBMS and RDBMS.

### Subject/Object Oriented DBMS

This KM System can be built on a Subject/Object Oriented Data Base Management System. The Subject Orientation aspect will be responsible for quick linkages and segmentation of storage. Multi-dimensional Subject Structure will be implemented under this structure.

The Object Orientation aspect will be responsible for storage and linkages among Knowledge Objects. The standard features of OODBMS will also be included to accommodate the inherent nature of Object Orientation.

Subject/Object Oriented DBMS therefore should include the following designed features:
Management of storage, memory and accessing efficiency by Subject Segmentation
Management of relationship by Relational Mathematics.
Management of Object Structure by Object Oriented Concept.

### Physical Design—Content of Knowledge Objects

### Multi-Media Content

Most Knowledge Objects contain information presented as text, audio, graphics, photographs, and videos etc. Multi-media content enhances the efficiency and effectiveness to convey information to knowledge seekers. Presentation may include background arts and music when desirable.

### Special Presentation

Some types of information may be presented in special formats. Examples include presenting demographic information on a map, statistical graphics, web pages etc.

### Procedural Content

Some Knowledge contains procedures, or conversational procedures. It may be desirable to document those procedures with some type of script, or interpretive, programming language. These programs are easy to change and can be executed immediately after change.

### Information Processing Content

Part of the knowledge may include processing of data. The following are some of the methods:
A Knowledge Object may contain executable program codes, to be downloaded to a user computer for execution.
A Knowledge Object may contain triggers in procedural content. When procedures are executed, the user computer sends the trigger and related data to the server computer for processing.

### Physical Design—Base Level Processing Functions

These processing functions are foundation to develop higher level program modules.

### Basic Subject Processing

Processing of Subjects includes the following:
Add a Subject
Modify the content of a Subject
Obsolete a Subject (instead of physical delete)
Link a lower level Subject to a higher level Subject
Modify content of the linkage (including linkage type)
Search for a Subject
Identify a Subject Space of selected Subjects

### Basic Object Processing

Processing of Objects includes the following:
Add an Object
Modify the content of an Object
Obsolete an Object (instead of physical delete)
Link a lower level Object to a higher level Object
Modify content of the linkage (including linkage type)
Search for an Object
Identify all component Objects of a selected Object
Identify higher level Objects of a selected Object

### Subject and Object Relationship Processing

Processing of Subject to Object relationships includes the following:
Link an Object to a Subject
Detach an Object from a Subject
Modify content of the linkage (including linkage type)
Identify all Objects related to a Subject
Identify all Subjects related to an Object

### Inquiry Processing

Base Inquiry Processing includes the following:
Match a Subject to the Subjects already defined and returned content if found
Match a Object to the Objects already defined and return content if found
Based on the Subject Names matched, pull out the related Subject Space
Based on the Object Names matched, pull out the related Object Structure
Based on the Subject Space identified, pull out all related Object Names

### Physical Design—Interaction with People

### Design Objectives

The main objective of this design is to provide simple and easy interfacing mechanisms with people. The two major considerations are user situations and available technologies.

### Interface through Verbal Communication

Speech Interfacing is essential for visually challenged people, and everyone in driving or walking mode. This KM System will have the capability to recognize voice input instead of touch sensing and key entry. Verbal output will also be a user option.

### Interface through Graphics and Animation

Graphical presentation of Subject Structure and other relationship will be included. Different graphic may be designed for different Subject. Animated characters will be attractive to children and used for special situations.

### Language Translation

There will be tools to translate from one language to another, or interface with existing translation software.

### Large Display and Multi-point Touch Screen

This KM System will transform the display to make good use of large screen and multi-point touch sensing interaction. Most displays will be in separate windows for easy user manipulation and parallel viewing. Large screen will allow more graphical presentation with more content information. Users will be able to work effectively with both the Object Structure and Subject Structure. User may also use this KM System as presentation tool.

### Handheld and Small Screen Computing

This KM System will make good use of handheld devices. Presentation format will suit the smaller display screen of handheld devices. The system will break up its display content into multiple pages for clear display and easy viewing.

Other options will include options for partial display, listing instead of icons, summarization, abstraction etc. Another option is to switch to verbal mode and all dialogues will be verbal based.

When handheld device is carried around, users may capture activity records as Knowledge Objects and related back to the personal Subject Structure.

### Physical Design—Working with Other Technologies

This KM System will include design and software to work with other technologies, including those stated in this section

### Multimedia Capability

This KM System will permit storage of and connection with, files of standard multi-media formats. Authors will be able to present their knowledge in multi-media.

### GPS Systems

When geographic location is defined as a Subject, it can interface with GPS by location. All Knowledge Objects related to a particular location are therefore accessible through this interfacing.

### Search Engines

This KM System will work with selected Search Engines to search out knowledge, or to connect with other knowledge contents in the public sector or in corporations. This leads to two kinds of extension. The first kind is as search agent to attach related information. The second kind is for users to do ad hoc research.

### E-Commerce

This KM System will interface with selected e-Commerce software for placing advertisements, announcements, transaction handlings and other business activities.

### Artificial Intelligence

This KM System will work with Artificial Intelligence software, especially for Decision Modeling. Artificial Intelligence will also be used to periodically verify and organize the relationship among Knowledge Objects.

### Design for Future Technologies

New knowledge formation software may scan documents for knowledge and create feeds for this KM System. Logical structure of this KM System is simple and hence convertible to data managed by new database management software. Human machine interfacing is simple, and can work with new software and hardware directly, or through middleware.

General interfacing with other technologies may be direct, or going through middleware. For direct interfacing, it will be in the form of standard requests with standardized parameters. Customized middleware may be developed to handle a particular type of software.

### Physical Design—Usability

### Design Principles

The core portion of this KM System will reside in a Web (Internet or Intranet) environment but will also work with personal computers. This KM System will provide various graphical presentation and functions for efficient and effective navigation through the Subject Space, Object Content, and Subject to Object Relationships.

Good usability of this KM System includes the following tools and procedures.
Procedures to navigate effectively through the Subject Space, and zoom in and out through the dimensional definition
Procedures to examine all Objects related to a chosen Subject, and the procedures to select Objects for review and comparison
Procedures to examine the related Subject Structure of a selected Knowledge Object, with both top down and bottom up scaling.
Procedures to zoom in through the Object Structure, and examine its related Subject Space
Procedures to dynamically zoom in along both Subject Structure and Object Structure, in order to learn the knowledge
Procedures that, effectively and efficiently, utilize different people/computer interfacing hardware and software
Effective and efficient tools and procedures for authors, learners and other kind of users

The display of both Subject and Object Structures will be flexible. Users may select graphics of their favor. For example, the display of the Subject Space may be in the form of hierarchy, bubble charts, or rows. The display may include all the defined dimensions, or only those related. The display of levels may also be top down, or bottom up.

### Display Types

In general, there are four major displays.
Display of Subject Space and moving up and down its structure
Display of all Knowledge Objects related to a selected Subject Space
Display of the Knowledge Content of the chosen Knowledge Object
Display of the relationship among Knowledge Objects

The display of one or multiple components of the above may be dynamically combined and varied according to a number of factors. These factors include service requests from the users, the size of screens used by the users, and the related application functions.

### Zoom-in and Zoom-out of Subject Space

This may start with one single Subject Name. The display returned will include both going up and going down the Subject Structure. One method to display the Subject structure is shown below.

Going up one level (zooming-out) will be displayed in one Window. It may lead to multiple higher level Subjects in many-to-one situation. The content will be like “Subjects above Subject 1: {Subject A, Subject B, Subject C, }”

Going down (zooming-in) the Subject Structure is displayed in another Window. Display of two levels down is a matrix of the following:

Row 1: {Subject 1.1: Subject 1.1.1, Subject 1.1.2, Subject 1.1.3, . . . }

Row 2: {Subject 1.2: Subject 1.2.1, Subject 1.2.2, Subject 1.2.3, . . . }

Row 3: {Subject 1.3: Subject 1.3.1, Subject 1.3.2, Subject 1.3.3, . . . }

Etc.

User may zoom in by selecting one or multiple choices in each row.

### Display related Knowledge Objects

As one user zooms in or out the Subject Structure, all Objects related to the defined Subject Space will be displayed with names only, in another Window. Users may select one or a few Objects for comparison purpose.

### Display content of Knowledge Objects

When a Knowledge Objects is selected, its content will be displayed in another Window. The display will be by pre-defined and related display background and format.

### General User Tools and Procedures

Users will normally go to the Internet/Intranet Server directly to find knowledge and information. The functions for knowledge users will include the following:
Enter any Subject Name, return all Subject Hierarchies including that name
Select Subject hierarchy, return related knowledge Object List
Enter any word in Object Name, return all full names of Objects that contain the entered word
Select any Object, return all Subject hierarchies related to that Object
Presentation will make use of graphical tools, URL, hyperlinks and buttons

### Search for Knowledge

This KM System will provide the following effective and efficient navigation and searching features for knowledge seekers:
Find the whole Subject Space related to a selected Object and allowing user to adjust and drill down alone any set of Subject Dimensions and Sub-dimensions
Find all components of a selected Object and allowing users to drill down to the proper level and component
Find all Objects under a selected Subject Space and allowing users to select the appropriate Object for review
Dynamically navigating and modifying both the selected Subject Structure and Object Structure in order to zoom in and focus at the required knowledge.
Using multiple display windows for effective navigation and searching.
Narrow down to the required knowledge.

While there are many combinations of the above to form various computer and user dialogues, the following is one example of general inquiry design:
This KM System displays a screen allowing users to enter what they know about Subject Names in the upper half, and Object Names in the lower half of the screen.
This KM System will search the Knowledge Data Base to find the closest matches of all Subject Structures and

Objects and display the results that match with the input, by each Subject Space and all Objects available under each Subject Space.
Users then narrow down or modify the choice to one Subject Structure and one Object Name.
The KM System then displays the Knowledge Content of the chosen Subject and Object.

### Study the Knowledge

When the required Knowledge Object has been identified, a user can further study the knowledge by the following options:
Go up and down the Object Structure for generalization or specialization.
Zoom in or zoom out to narrow down or to expand the studying, by selecting some of the displayed Objects.
Study only the abstraction or high level information, or expand the studying to include linkages to external information, other users' comments etc.

### Variations in Knowledge Presentation

This KM System has functions to present different kinds of knowledge in different formats, through the following mapping processes in the system:
Different background pictures/graphics for different high level Subjects.
Explicit presentation format for a group of Objects with similar content.
Explicit presentation format for a publication, by Subject/Perspective.
Defaulted presentation format by high level Subject.
User selected presentation format
Equipment dependent presentation format

### Variations in Structural Presentation

There will be several hierarchical structures to be presented, from Subject Groupings to Subjects, from Subjects to Perspectives, and from Perspectives to Knowledge Objects. This presentation may take the form of a hierarchy, a matrix, a spreadsheet, or any other suitable graphical formats, including geographic maps and statistical graphics.

### Authoring Tools

This KM System will include a PC version of Authoring Tools. Authoring may be done in a PC and uploaded to the Web later. Users may also download knowledge from the web for modifications. There will be dialogues to guide authors for downloading or uploading. Authors may select various options for layout, presentation and maintenance.

This KM System can pick up traditional writing and transform the text into a preliminary version of Subjects and Objects. Author may turn text book to dynamic content managed by this KM System.

### Learning and Research

This KM System will include a PC version of this KM System for users/learners. Users may organize their personal knowledge and dynamically link it to this KM System.

Additional tools will be provided to facilitate personal learning, including the following functions:
Selectively download a segment of Subject Space and merge with the personal Subject Space.
Interactively link between personal knowledge and public knowledge base.
Downloadable tools and utilities for learners to search out internet articles and related tags. Users may turn unstructured information into structured information by the related Subject Space.
Track learning history.

### Physical Design—Integration or Interface with Existing Popular Systems

### Design Objectives

Design of this integration or interfacing is two way traffic of knowledge. This KM System may download knowledge from other systems, or provide knowledge feeds to other systems. Some examples are included below.

### GPS

GPS System may be treated as a special Subject, namely the geographic dimensions. Locations identifiable from the GPS System will be mapped to the locations kept in this KM System. Area of interest will be a Subject Space and various Knowledge Objects can be retrieved from this KM System. The resulting knowledge information can then be displayed on any GPS equipment, or other equipment that work with GPS System.

### Travel Information

This is a functional extension of GPS applications. When one is travelling with equipment that has GPS positioning, GPS applications can pin-point the traveler's position. Various travel information is in Objects related to the Subject of GPS positioning. Users can at any time examine the content of any travel information Object to find out the details. These can be a list of nearby facilities of any type, history of any building, or other information for travelers.

### E-Government

This KM System can function as an entry point to e-Government Connection to this KM System in the public domain may be by country, state, city, or municipality etc. Once in the web site of a Government, this KM System can also be used to structure their knowledge, including e-Government functions.

### Legal Information System

Where Government has electronic version of the law of the land, this KM System can function as an entry point to the various regulations and law sections. Connection to this KM System in the public domain may be by country, state, city, or municipality etc.

### Physical Design—Management of Knowledge Library

### Subject Space Restructuring

Tools designed for structural maintenance of Subject Space include the following:
Add a Subject Dimension at any level
Change the name of a Subject Dimension
Delete a Subject Dimension

### Object Relationship Restructuring

Tools designed for structural maintenance of Object Relationship include the following;
Add an Object Component (sub-set)
Change the name of an Object Component
Delete an Object Component

### Restructuring of Subject to Object Relationship

Tools designed for structural maintenance on Subject to Object Relationship include the following:
Add a relationship
Delete a relationship
Modify a relationship by modifying the selected Subject Space

### Security Control

This KM System will work with Security Control System so that authority of maintenance may be assigned to people of various roles and responsibilities, such as the following:
Subject Editors to maintain Subject Space
Authors to maintain Objects, Perspectives and relationship between Objects and Subjects.
Authors to send changes to Editors for approval before publication.

### Time Dimension

All filing of knowledge Objects and affiliated artifact, including comments and attachment from the public, will be time stamped. Time scale is treated as a separate dimension. User may see the time of all artifacts from any Subject Domain Users may also select and review all filings within any time segment under any Subject Space.

Knowledge will not be deleted after publication, but may be archived and replaced by newer knowledge. For knowledge that is time sensitive such as weather record/forecast, users will be able to select by any point on the time dimension.

### Physical Design—Knowledge Integrator

### External Knowledge and Information Libraries

Information is already plentiful in the existing Internet World. However, usability of these information libraries may be much limited by the lack of relationships between Subjects and Objects. This KM System is designed to interface with other knowledge and information libraries.

Using different interfacing software in between, this KM System may submit periodic search to those libraries by stating the Names of Objects and Subjects in the proper format. The interfacing software will also be able to make use of special features of those libraries such as Tags, Word Clouds, Indexing, Table of Content, and Key Words in articles and library catalogues.

Once found, this KM System will establish linkages and put those linkages in Knowledge Objects for users to fast track to those web sites, literatures and multi-media contents.

### Tagging of Existing Electronic Articles

Many existing electronic articles are already extensively tagged. These tags can be linked to the Subject Names and Object Names. Knowledge seekers may selectively examine these existing articles.

### Search of Existing Publication

Users of this KM System may pick any Subject or Object and call upon various Internet Search Engines to locate related Internet publications.

### Search of Existing Information Library

Users of this KM System may pick any Subject or Object and copy over to the searching tags of other Information Libraries such as newspapers and professional libraries.

### Application Design—Common Features Among Applications

### Design Objectives

All applications will be Knowledge Based include training programs, user manuals, business processes, procedures, processing functions, control and audit trails etc.

Some Applications are just methods and procedures to use this KM System for a particular purpose. Some other Applications may include both explicit usage procedures and additional programmed functions.

The following describe some contents and structures of a knowledge based application. A generic algorithm is to use a script interpreter that can read predefined syntax and semantics of procedures to trigger other Knowledge Objects that contains training materials, work steps for human and executable codes for machineries.

### Application Architecture

The Subject Structure is by default the Application Architecture with inherent benefits that include the following:
Dynamically modifiable at any time
Flexible in bundling and packaging
Visible, understandable and fully documented as Knowledge Objects
User may access the required functions and features by various intuitive Subject Names, or through well-defined business processes and procedures.

### Comprehensive Content

Application contents include but not limited to the following:
Pre-requisite Knowledge to use that Application
Training Programs or Self-learning Programs
User Manuals
Embed Knowledge in that Application
“HELP” information
User procedures
Application Functions
Test Cases

### Combine Knowledge for Humans with Knowledge for Computer Machineries

This KM System stores Knowledge for humans and Knowledge for Computing Machineries. With proper combinations for presentation and interpretation, all applications will be more efficient and more effective. Automation will be at a high level from learning about, to execution of the Application.

### Computer Functions Integrated with Operational Procedures

Business Processes are defined as Knowledge Objects that contain operational procedures with embedded triggers for Data Processing. Audit Trails will be created as Knowledge Objects during Data Processing.

### Execution Control

Application Functions include sequenced procedures. Procedures include schedule driven functions and On-demand Functions. For schedule driven Functions, users can pre-set and adjust the schedules as needed.

### Resulting Objects and Audit Trail

All records created by an Application are time stamped and journalized as Audit Trail. Security control may be applied on both data and functions. Usage of an Application will be monitored. Variances and mistakes will be tracked and reported.

### Integration and Packaging

Integration is by default through the Subject Definition and linkages among Objects. Packaging is by pulling out all related Objects within the selected Subject Space.

### Subject/Object Oriented Business Knowledge

A Subject Space defines the business scope of an application. Usages of an application are structured into multi-level Business Subjects. Different templates are included for different segmentation and operational aspects. These templates guide users to go through various Subjects in order to conduct a group of activities.

Each Application Function is a Knowledge Object that may be broken down into a sequenced series of lower level Objects each containing a set of procedures. A set of procedures can also be broken down into a sequenced series of Objects. Each Object contains a manual step or an automated processing function.

For execution of procedures, coding will be included in the Knowledge Objects to enforce mandatory steps and to guide the optional steps. Audit and control requirements can be embedded in these procedures.

Subjects, Objects and Relationships together provide a flexible and dynamic method to define processes and procedures of an application.

### Perpetual Evolution

Any portion of an application package may be altered at any time by altering the content of related Knowledge Objects. When an Object is modified, all applications including that Object in its content are also modified by implication. This provides a powerful and effective architecture for application maintenance and enhancement.

There is no limit in number of applications under the structure of this KM System.

New Knowledge Objects may replace old Knowledge Objects. Replaced Objects will be archived but not deleted, leaving a full Audit Trail on the evolution of the application.

### Effective Testing

Test cases and test results may be included as Knowledge Objects, and evolve with the Application. Testing can be re-run as often as required. Test results will be in Knowledge Objects, as Audit Trail of testing.

### Generic Algorithm

The following table describes generic high level algorithm of Application Design.

### Generic Algorithm of Application Design

| Step | Complete Procedure | Step | Short Cut/Option/Alternative |
|---|---|---|---|
| 1 | User of Application specify the problem or | 1A | Experienced user goes directly into |
| | issue as Subject Space | | specific Application at Point 5 |
| 2 | User starts with high level Subject | | |
| 3 | User narrows down the Subject Space to | | |
| | find the related Application | | |
| 4 | User goes through the Training material to | 4A | Learned user skips all training and goes |
| | learn the Application | | to the next step |
| 5 | User select the correct Application Function | | |
| 6 | User execute the chosen Application | | |
| | Functions | | |
| 7 | Application direct user to go through the | 7B | Procedures may include data capturing, |
| | necessary procedures | | processing options etc. |
| 8 | The procedures may include machine | 8B | Executable codes of machines may |
| | Knowledge as executable codes for the | | include further directive and options |
| | machine | | including help function |
| 9 | User complete all procedures of the selected | 9B | Machine will create audit trail by |
| | Application | | design |

### Application Design—Personal Management

### Design Objectives

This KM System integrates all Knowledge to achieve personal time efficiency and action effectiveness. This Application encourages users to document everything in electronic forms with automated backup. It promotes paperless life-style, supports personal memory, and encourages life-long learning.

### Baseline Knowledge on Personal Management

The PC version of this KM System includes a downloadable set of Subjects and Knowledge Objects for Personal Management. Downloaded Knowledge will include a learning program on time efficiency, decision making, and action monitoring.

### Personal Knowledge

The downloaded Baseline Knowledge may be expanded by users to include Personal Knowledge such as contact information, important dates of the year, important personal data and special interest Knowledge. Links to frequently used external Knowledge can also be gradually added to this Personal Knowledge. Personal health records may also be included. Confidential Knowledge will be encrypted in the data storage.

### Baseline Functions

Baseline templates are downloadable to personal computers and customized by users. These templates include interfacing with other popular personal tools such as time management, contact directory and social media.

### Customized Functions

The baseline functions encourage users to enhance this Application by including the following:
Learn about Personal Management.
Integrate with other Personal Applications such as Learning/Research and Career Management
Set up personal Subject Space with security.
Distribute Knowledge Objects among public storage, home storage and portable storage.
Set up automated backup and other security measures.
Manage personal activities for efficiency and effectiveness (including diary, appointments, memo, notes etc.).
Interface with public KM System and other tools.

### Sample Subjects of Personal Management

| | | | |
|---|---|---|---|
| 1 Personal | 1.1 Time | 1.2 Personal | 1.3 Activity |
| Efficiency | Management | Planning | Monitoring |
| 2 Personal | 2.1 Contacts | 2.2 Important | 2.3 Life |
| Information | | Dates | Records |
| 3 Personal | 3.1 Career | 3.2 Knowledge | 3.3 Recreational |
| Interest | Interest | Interest | Interest |

| | | | |
|---|---|---|---|
| 2.1 Contacts | 2.1.1 Family | 1.1.2 Career | 1.1.3 Business |
| | Contacts | Contacts | Contacts |
| 2.2 Important | 2.2.1 Birth | 2.2.2 | 2.2.3 Holidays |
| Dates | Dates | Anniversaries | |

### Application Design—Personal Learning and Research

### Design Objectives

The basic need of a Knowledge User is to obtain information that is related to its interested Subjects. This KM System allows push-down or pull-in of new/changed Knowledge Objects within a selected Subject Space. Search may be performed in on-demand mode, or executed in deferred batch mode. The search results will be stored up for later review.

### Search Knowledge by Defined Subject Space

A Knowledge User may select and study Knowledge Objects in a Subject Space.
The Knowledge User enters a Subject Name at any level.
This KM System defines the Subject Space. The Application displays back the next 2 levels to go down (classifying) or up (categorizing) along the Subject Space.
The Knowledge User searches up and down the Subject Space.
When searching the Subject Space, the KM System provides options for various graphic displays in the same window, or multiple windows. This facilitates searching and computer/people interaction.
A separate window displays a name list of all related Knowledge Objects for the Knowledge User.
The Knowledge User marks down the Knowledge Objects to be analyzed and goes through those Objects one by one as required.

### Search Knowledge by Learner's Subject Space

A learner may customize a Subject Space and this KM System will search out related Objects in the public domain. This may be accomplished by the following steps:
The learner defines and fine-tunes the Subject Space of his/her study interest.
This Subject Space is compared with the Subject Space already defined in the KM System.
Discrepancies between the two Subject Spaces are reported back to the learner who may choose to fine-tune the Subject Space definition.
This KM System searches out all available Knowledge Objects related to the defined Subject. This may be done in on-demand mode, or executed in deferred batch mode.
Knowledge Objects from above will be downloaded to the personal computer of the learner.
The learner may store the downloaded Knowledge for future reference and study.
The learner may also set up a download request so that new Knowledge filed by authors will be pushed down to the seeker.

### Search Engine for Information in the Internet World

This KM System includes advanced Internet search engine to find related information based on the Subject Space defined by a Knowledge User.
This search engine breaks down multi-dimensional Subject Space into Sub-spaces and searches out information by component Subjects.
Where an information library has indexes or tags, this KM System searches through the tags to find potential matches.
Available Information is presented to the Knowledge User by its component space.
The Knowledge User then filters out the irrelevant information and files the relevant information by its own Subject Space definition.
Users can trim down video and audio scripts and file only the related portions.

### Establish Common Search Paths

This KM System registers search paths and highlights those for Users.
When Subject Space is displayed, the commonly searched Subjects are highlighted for the Users.
The more popular Knowledge Objects within the related Subject Space are displayed in a separate window.
Users are free to search along any path, or go to the popular Knowledge Objects directly.

### Search by Unstructured Subject Names

Users may search for Knowledge in this KM System without a clear understanding of the related Subject Space.
Users may key in multiple Subject Names without any structure.
This KM System matches those Subject Names with the established Subject Space, and displays back the closest matching.
Users search up and down along the Subject Structure to find the most relevant portion of the Subject Space.
All the related Knowledge Objects are displayed in a separate window.
Users then inspect the content of those relevant Knowledge Objects.

### Q & A Session

This KM System can transform simple question for Knowledge into Subject, Object and Attributes of Object It searches for related Knowledge and presents back to Knowledge Users. Standard interaction may include the following:
The Knowledge User asks a question. The KM System interprets the question and responds back to User with its interpretation on Subjects, Objects and attributes.
The User revises the question or search out the related Subjects. The KM System responds back with related attributes.
The User selects one or more attributes. The KM System responds back with the related Knowledge.

### Application Design—Career Management

### Design Objectives

The purpose of this Application is to enable a person to manage career under a systematic structure. Considerations include career objective setting, career path planning, career development and career management etc.

### Baseline Career Knowledge

A set of Subjects and Knowledge Objects for Career Management is downloaded to the personal computers of Users. This Knowledge includes a learning program on career management, including resume writing, interview techniques and career related web sites etc.

Users may use this Application to explore Knowledge on various industries, professions and employment opportunities, both statistical and latest news.

After acquiring some general Knowledge, Users may customize a career program that includes learning, preparation and actions on career development.

### On-Going Career Management

Included in the downloaded baselines are Knowledge and computer functions for on-going career management. Selected career related web sites and their Knowledge contents will be downloaded, and updated at any time.

For Users who have chosen to plan a career path, this Application will monitor progress over time. This Application will remind Users to review progress and to take career actions.

When necessary, this Application will recommend Users to seek professional helps and services, either through this KM System, or through advertised service providers. For those who obtain professional services, this application provides the necessary Knowledge to evaluate the effectiveness of services received.

### Peer Supports

Through this Application, Users may share experiences and opportunities with peers. By linking to popular social media and web sites, this Application can serve as an integration point for peer supports, mentoring, experience and opportunity sharing, etc.

### Application Design—Formal or Official Authoring

### Platform for Multi-Dimensional Writing

This KM System allows authors to write and publish their electronic books in a dynamic way. Authors may include multiple presentations, multiple Tables of Contents and more effective indexing for readers.

### Platform for Periodical Publication

This Application may be used to publish electronic version of periodical magazines and newspapers. For this kind of publication, the Subject space is normally stable but evolves gradually over time. Articles may be written differently, with small sections and in digest form. Articles are categorized by more than one Subject. In other words, an article may virtually appear multiple times under various Subjects and Tables of Contents.

Older articles may stay on in the Knowledge Database for a fixed amount of time, or indefinitely. As a general mle of time stamping all Knowledge Publications, all writings will be dated. Publications under this KM System can replace paper publications of any kinds.

### Platform for Authors to Research

This Application includes software to scan all e-publications, and links the contents to selected Subjects as proposed references. Authors then read those proposed references before writing further on the related Subjects.

### Writing, Editing and Publishing

This Application includes proper control on writing and publication. Authors control their own writing. Subject Editors will edit before publishing. Editing will include verification against duplications and conflicts. There will be separately controlled storages and processing functions among writing, staging, editing and publishing.

### Bottom-Up Writing

An author may document and publish a group of Knowledge Objects over a period of time before linking those together to form Perspectives. This Application includes functions for authors to publish a Perspective linking Knowledge Objects in a certain sequence. The Perspective may link to one or multiple Subjects.

### Top-Down Writing

An author may follow these procedures to research and write on a Subject:

Stage 1—An author selects a certain Subject Structure that is already defined in the system.

Stage 2—The author reviews all existing Perspectives and Objects to prepare a new Perspective with Table of Content, and sends it to the Subject Editors as a writing proposal.

Stage 3—After the Writing Proposal is accepted by the Subject Editor, the author downloads all necessary contents to a PC for further writing.

Stage 4—After the writing is completed, the author uploads the contents back to the KM System. Further processing includes verification against duplications and conflicts, and approval by the Subject Editor.

### Powerful and Dynamic Content

This KM System enables authors to include dynamic and powerful content in writings. Each section or even paragraph may be treated as an Object. An Object can be multi-media, as well as pre-programmed functions. An existing writing may be modified to include multi-media presentations, and even processing functions.

### Quick Conversion and Integration with Existing Writing

This KM System can include existing writing with the following quick method. Authors may republish their existing writing in this KM System.
The writing is a Knowledge Object with the Title as Object Name. The Title and the author together form a unique Subject Space in this KM System.
The Table of Content of the article will form lower level Subjects under the Title as a high level Subject.
Existing/created Index and Tagging are mapped to defined Subject Structure in the KM System, and the related sections/pages are related Knowledge Objects.
Existing content by chapters, sections and paragraphs may be converted to a series of sequenced Knowledge Objects and related to the various Subject Dimensions from above.

### Restructure and/or Rewrite Existing Publication

This Application provides software to restructure and rewrite existing articles or books. Procedures include the following:
Authors capture existing publications in electronic form.
This Application examines the electronic documents and creates multiple Subject Structures based on Table of Content, Indexes of Key Words, paragraph headings etc.
Authors and Editors may fine-tune the above Subject Structures. Author may also create or customize additional Subject Structure based on generic structure in various subject areas.
This Application creates linkages from various Subject Structures to the related content in the related articles and books.
This Application presents the results from the above in a new format, showing Subject Structure and related Knowledge Content.
Authors may rewrite and restructure the writing into better Knowledge Structure manageable by this KM System.
The end result may be well structured Knowledge Objects in various Subject Space, or semi-structured linkages between Subject Structure and the related segments of the articles and books.

### Application Design—Fictional or Novel Writing

### Platform for Multi-Dimensional Novels and Creative Writing

This Application enables authors to document fictional events. Instead of standard structure in traditional hardcopy novels, authors may create multiple alternative scenarios depending on the decision made by the various characters in the novel. The Decision Table of all characters maps to multi-dimensional Subject Space. Novel scenarios are Objects in various positions of the Subject Space.

A reader can make decision for a character. Different scenarios will be displayed for different decisions. A novel may be multi-media in content including interactive video. Novels become much more sophisticated and hence more interesting to read.

### Time as a Subject Dimension

Chapters of this kind of novels are now time durations of the story and one of the Subject Dimensions of the novel.

### Characters as Subject Dimensions

Characters of the novel are Objects of the novel. They are also separate Subject Dimensions as each character is free to make decisions.

### Decision Making as Subject Dimensions

A decision implies multiple choices. These multiple choices for a character at a certain time represent sub-dimensions for that character in that time period. All the decisions from all characters together may be presented as a Decision Table or Decision Tree against the Time Dimension. This is a summary of all scenarios in the novel.

### Scenario as Objects

Related to each Character Subject and at a certain Time Duration, the Character perceives a certain scenario. Description of that Scenario is stored as an Object. A Scenario Object observed by various characters leads to various decision making Different decisions made by each character may lead to different scenarios and hence different Scenario Objects.

### Interfacing Design for Authors and Readers

Front ending presentation tools will be developed to assist Authors and Readers instead of the traditional Indexes and Tables of Contents. This will enable both authors to write, and readers to read the novel. Presentations of the contents will be multi-dimensional including graphical tools such as decision tables and decision trees.

### Application Design—Periodic Publication

### Design Objectives

This Application is for any type of periodic publications from daily newspapers to periodical magazines, and even annual reports. The content is in electronic format and of multi-media.

### Standard Table of Content for Periodicals

Editor of periodic publication sets up a Subject Structure by article types as a Standard Table of Content. The Authoring Application is used by authors to submit their articles to the editors.

### Contents and Indexes

This Application scans articles for words. These words are matched with the Subject Structures. The articles are linked to the matched Subjects. Editors will fine tune the linkages between Subjects and articles. When all articles are ready, all the related Subjects will be included as final Tables of Contents. All relationships between Subjects and Objects function as pages and paragraphs of articles. Relationships may be sorted in alphabetical sequence of the Subjects to form an Index of a publication.

### Published Content and Format

With the contents described above, the publication includes the following:
As traditional publication in content and format that may be read as a book;
As Knowledge base content that may be accessed through the Subject Structure;
As references by Subject Index;
Filed in the library of the publisher for future usages;
Made available to external libraries, to be searched and accessed by Subject Names.

### Application Design—Informal Authoring

### Knowledge with the General Public

This KM System allows people to contribute and document their Knowledge and experience in an informal way, with or without revealing personal identification. There are a number of ways to perform informal authoring, and to share experience with the public.

### Discussion Forums within any Subject Space

This KM System allows anyone to open a Private Forum in any segment of Subject Space. A Forum Creator selects a Subject Space by selecting one or multiple Subject Names. Then the creator posts a question or a statement to start the discussion. A Fomm Subject is then created and linked to the related Subject Space. Some standard semantic options are available for Private Fomm Creators to select and apply to that Forum. All discussions and opinions within the Private Fomm are Knowledge Objects.

### Open Forum on any Knowledge Object

Any Knowledge Object contains a link to a Public Fomm where people may express their opinions, or share experiences, with or without revealing identity. Host of this KM System will disclaim responsibilities and liabilities regarding correctness of published Knowledge. Users will be reminded to use caution when picking up Knowledge from Open Forums.

### Questions and Answers Related to a Knowledge Object

Any person may post a question related to any Knowledge Object or Subject Space. Once a question is posted, it is registered in both the overall log of all questions and the individual log of questions against any Object or Subject Space.

### Application Design—Interfacing with External Media

### Design Considerations

Much information may be found in media that includes television, newspaper and magazines. The web sites of these media contain significant amount of information that are updated regularly. This KM System will provide easy access to this type of information.

### Standard Linkages to External Media Web Sites

Subject Space and Knowledge Objects may link to established web sites. Users may use the internet search function in this KM System to dynamically search out information in External Media.

### Regular Search by KM System

This KM System regularly searches out the contents of External Media, and updates linkages from Knowledge Objects to the related contents in External Media.

### Regular Updates from External Media

External media that have regular publication of Knowledge may download Tables of Contents and related those to the Subject Space of this KM System. Users can then link from the Subject Space of this KM System to the contents of those media.

### Application Design—F-Commerce

### Design Considerations

E-Commerce is already a common practice with many features and functions. This KM System can add efficiency and effectiveness to identify the products and suppliers that are most closely related to the preference of buyers.

### Establish Industrial Standard on Product Attributes

When there is commonly recognized attributes of a group of similar products, these attributes form subject space of the related group of products. A subject space can be defined with the Product Group placed as industrial standard of related attributes. Buyer can find this Product Group as Object by name or by searching down the Subject Space.

### Establish Common Standard on Supplier Attributes

Attributes of similar type of suppliers can be complicated but may be reduced to some key attributes such as history, size, financial strength, quality reputation, local/regional/global etc. These attributes then form a Subject Space of suppliers and with Object as commonly recognized standard of those attributes.

### Establish Supplier Provided Attributes and Customer Evaluation on Suppliers

Based on the standard attributes established on similar type of suppliers, a supplier can provide their own claims and customers may provide evaluations based on their experiences to deal with a supplier.

### Procedures of E-Commerce with this KM System

Before going into typical E-Commerce procedures on business deals, this KM System provide efficiency and effectiveness on the following:
1. Customer can easily define their expectation on product attributes and supplier attributes.
2. This KM System can perform the necessary search and comparison before recommending both products and suppliers to inquiring customers.
3. Customers may evaluate suppliers based on their claims and evaluation from their customers.
4. Customer can then narrow down the selection before going into further e-commerce procedures such as bidding, contracting and transaction processing.

### Application Design—Decision Making and Knowledge Extension

### Design Considerations

Decision Making is a Subject by itself. But decision is often triggered by a warning, or caused by anticipating a situation. A decision is made at the intersection point among multiple Subjects, as context of making that decision.

Decision is making a choice among a number of options, based on some facts, some assumptions, and some understanding of the pros and cons of each option. A decision does not preclude modifications or adjustments down the time-line when better understanding is developed, or changes in the situation are observed.

While casual or informal decisions are common in daily lives, serious situations call for a formal decision process. This Application is designed to assist and record such a process.

An intellectual decision process may include the following steps:
1. Perceive a situation that requires some decisions.
2. Identify the purpose and expected result of the decision.
3. Scope out the study and consideration.
4. Research and select the applicable information within the defined scope.
5. Analyze the applicable information to determine available options and possible outcomes of those options.
6. Evaluate possible outcomes and determine risks of those options.
7. Decide on a course of actions.
8. Define the expected outcome and how to measure for success.
9. Execute the decision and measure result.
10. Conclude effectiveness of the decision.

This Application is designed to guide and to capture the Intellectual Decision Making Process. This Application is particularly useful for group decision. It covers a scope from situation analysis to analytical model and then completion of a Decision Model.

### Establish a Case of Decision Making

A decision is triggered by perceived problems, or opportunities. This Application allows decision makers to create an Object as a Decision Case that contains abstracts or summaries of decision triggers, considerations and requirements. This Object is then positioned in a Subject Space that defines the problems, opportunities, implications and considerations.

When the above is clear and reasonably accurate, the decision scenario will become a Knowledge Object as a Decision Case. This Object is positioned at the above-mentioned intersection of related Subjects. It is the foundation to build an Analytical Model or Decision Model.

### Background References and Situation Analysis

A decision maker goes through Knowledge Objects within the related Subject Space. Those Objects that are relevant to that decision making will be selected and connected to the decision scenario/context. Former related Analytical Models and Decision Models may also be included.

A decision maker analyzes the information in the selected Objects. Some Objects may be dropped and the remaining Objects become analytical parameters. After this process, the Case Object may be considered as a Subject with Space defined by its scope of consideration.

The Decision Case Object is now linked to other Objects as parameters of the decision. This is a decomposition of the Decision Case Object into components of considerations.

This Application includes functions to place information/knowledge Objects side by side to create a bigger picture that may lead to better understanding. This is integrating Knowledge to form context and perspective. Some seemingly unrelated Knowledge may be viewed together in larger context to develop better understanding.

### Analytical Models

In making a decision, some Knowledge Objects from the above will be marked as alternative considerations with justifications and quantifications (when applicable). The other Objects will also be marked as not chosen with justifications. The result is an Analytical Model of that decision case. There will be multiple Analytical Models accumulated with different contents, but for similar decisions, and related to more or less similar Subjects.

The various Subjects included in the considerations of an Analytical Model define the Subject Space of that model. The selected Knowledge Objects linked to that Analytical Model are related Knowledge for that analysis.

Analytical Models can be of a wide range of complexity. A simple Analytical Model may include the chosen attribute of that decision, and relied reference information. A complex Analytical Model, on the other hand, may include alternative possible decisions and projected outcomes of each alternative decision.

When a new case comes alone, a decision maker can search by related Subject Space to get previous similar cases as references. Previous Analytical Models of similar situations serve as useful references to quickly define the new Analytical Model.

### Decision Models

After the analytical model has been built and the decision has been made, this Application may proceed further to monitor the execution and outcomes of the decision.

When the decision is proven as effective, the related Analytical Model matures into a Decision Model. A valid decision in the past represents a valid experience, and serves as a valid reference Knowledge for the future. However, it needs not be the best decision in the past, or a valid decision for the future, even under exactly the same situation.

A Decision Model is a Subject by implicating other Subjects for consideration. A Decision Model is also an Object with component attributes for considerations, component actions of the decision, and component outcomes as history.

It is conceivable that similar situations may include multiple Decision Models in the past with different contents. A Decision Support System can make use of these Decision Models as references for future decision even if the premises may not be exactly the same.

### Group Decision Functions

The features and functions described above are good for personal decision making Additional functions will be included to facilitate group decisions. A Decision Coordinator uses these special functions to invite and collect input from multiple parties. These parties may vary from a small committee to the general public. Input to this Application can start from initial information gathering, to opinion gathering, and finally to decision voting. Statistics will also be generated and updated to reflect the opinions gathered.

### Wisdom Extends Knowledge

Data are words or numbers. When words form phrases and sentences, and when numbers are described to mean something, data become information. When information is understood to be applicable to specific situations or usage, it becomes Knowledge. Wisdom is the ability to apply previous Knowledge to a new situation, and make correct decision to deal with the new situation. Decision Models are past wisdom turned into reference Knowledge for the future.

### Application Design—Artificial Intelligence

### Input Capturing

For the scope of this Application, Intelligence is the ability to decide and act based on knowledge. From the preceding Application, input of Decision Making Process may be captured as Knowledge Objects and data captured through application procedures. Input for Artificial Intelligence may be captured likewise.

### Artificial Intelligence for Decision Making

Decision model by itself is a recording of previous human intelligence. These models, once captured, may be considered as artificial intelligence for decision making Outcome of executing the Decision Model may be priorities or options for choices, with biases and risks explained. Human review should be a final procedure before confirming the final decision.

### Interface with External Artificial Intelligent (AI) Machineries

Input to Decision Model may also be fed into other Artificial Intelligent Machineries. This may well be a requirement if special purpose computer is used to drive machineries including robots. This KM System may then be used to capture and store inputs of various scenarios and push to, or pull by external machineries. This KM system contains a flexible and power structure of Knowledge Subjects and Knowledge Objects that can organize knowledge by small pieces and with fast access. This is a pre-requisite for driving Al Machineries.

### Application Design—Policy Decision by Group Intelligence

### Design Considerations

Policy type of decision may require in-depth synthesis and integration of group intelligence. This may be done by modeling the issues and concerns in the real world. By defining the scope of consideration, group members may input their issues, concerns, recommendations and resolutions in all aspects of considerations.

### Subject Space of a Policy Decision

A drafted policy decision is named as a high level Subject in this KM System. This high level Subject then links up a Subject Space to form the scope of consideration. This scope may be expanded by group members when additional considerations are desirable. This Subject Space then constitutes potential implications of that policy decision.

### Content and Structural Breakdown of a Policy Decision

The high level Subject of a decision is also a Knowledge Object containing high level description of the policy. A policy decision may include lower level details such as component policies, alternative policies etc. This structural breakdown forms component Objects of the high level Decision Object. It may also indicate the Subject Structure of that decision. Each component Object may implicate a different set of Subjects.

### Group Intelligence as Knowledge Objects

Group members can now input their considerations, concerns, issues, and suggestions etc., as Knowledge Objects in the Subject Space defined above.

### Evolution of Drafted Policy

Group members responsible for policy formulation can now modify the policy by creating new alternative policy details and other members may input new considerations and suggestions. This whole process then evolves over time until it is optimized and form a final set of policy details. This final set of policy details is now the final decision and may be implemented accordingly.

### Application Design—Organizational Standards

### Design Objectives

This Application is for customized development of Knowledge based Organizational Standards These Organizational Standards are the basis of all business activities from policies to operations. Subjects can be by standard segmentation of business administration at a high level. Lower level Subjects are refined by organizational units and management structure within each unit.

### Baseline Models

Baseline Models are the Academic Perspective of Management Knowledge. Different baseline models will be available for various types of industries, business types and corporation sizes, including large corporations, small businesses, governments, non-profit, charities, hospitals, schools etc. Individual organization may install a Baseline Model at the beginning The Baseline Model is then evolved over time by adding organization specific Knowledge. Subjects and Objects are all derived from the best academic standards. Models are most likely provided by research institutes or consulting firms.

### Professional and Industrial Practices

This Application includes Knowledge of best Professional, or Industrial Practices. The Subjects will be multi-dimensional including Clients, Projects, Processes, and Performance Standards etc. Subjects and Objects are all based on the combined wisdoms of professional and trade associations.

### Legal Requirements

This Application may be used to capture, maintain and retain legal requirements on various industries and organization types. Legal requirements include those for charitable, non-profit, educational, industrial or commercial organizations. Legal requirements for consumer protection, privacy and security will also be included.

### Integrate with Existing Knowledge of the Organizations

An organization may launch this Application to make good use of existing documentation and knowledge. For more effective management beyond that point, an organization needs to review and improve existing standards that may include the Subjects in the following sections. This application is an effective tool to ensure that an organization can set up minimal standards that are clear and obvious to all levels of management.

### Policy and Strategic Perspective

A Strategic Planning model will also be posted to guide an organization to formulate their strategies for competitive advantages. This is an example of Innovative Perspective for business users of this Application. Senior management can use this in top-down, and bottom-up communication, as well as strategy formulation mechanism.

### Program and Project Management Perspective

This Application may be used to capture, retain and maintain Program and Project Knowledge. Interfacing with other Program/Project Planning/Scheduling tools may include Office Computing Suite, and direct interfacing. Subject dimensions will include Program Definition, Project Management Life Cycle, Product Development Life Cycle, Product Standard, Legal Requirement etc.

### Work Flow and Operational Control

This Application may be used to manage and record work flow including work procedures, operational records and business statistics. Business Area Experts may use this Application to fully document their knowledge on business operations, for others to understand and follow. Employees may use this Application to document their questions, issues and concerns for management to address. Subjects are defined by organizational structure at high levels. Refinement of Subjects can be down to business units, operational teams, operation processes and even work tasks. Knowledge Objects will contain standards for related Subjects.

### Operational and Documentation Integrator

This Application allows corporations to integrate existing but loose documentation and then further enhance it over time. It may also be used to define standards and templates for all workers to follow and utilize.

### Quality Assurance

An organization may set up quality standards for various organizational groups/teams and/or various business programs and activities. Subjects define organizational units, business units, product groups, and finally products/services. Objects contain quality standards, assurance methods and quality statistics etc.

### Performance and Competency

For programs, projects or operational controls, performance and competency standards may be established to document and monitor deviation. Performance and competency controls may also be set up in multi-dimensional ways, and managed likewise.

### Internal Audit

This Application allows corporations to setup and enforce standard practices and procedures in business propositions, product developments, project management, and business operations. This is done by setting up special Subjects and Tables of Content as Subject Space. With this setup, auditors can track and check actual performance against corporate and professional standards. Objects are audit procedures, standards and reports, linked to related organization structures and business operations as Subjects.

### Application Design—Organizational Planning

### Design Objectives

This Application is for business planning from strategic level to operational level. Multi-dimensional breakdown of Subjects can define both top-down and bottom-up planning, from corporate level to operating unit level. Subjects include Strategic Planning at corporate level and Operational Planning at business unit level. Financial plans can be consolidating upwards from business unit to various corporate levels. This Application integrates all considerations, and facilitates a complex business planning process.

### Planning Model

To develop an organization specific Planning Model, one starts by acquiring an academic model. The next step is to enhance the model to suit the organization Templates and interfacing tools will be included to assist senior management in customizing an academic model to organizational specific model. This model can be further revised and enhanced in subsequent years, to accommodate changes in the business environment, competition, and organizational changes.

### Top-Down Policy and Strategy Formulation

There can be several steps of planning to formulate corporate strategies.
Link the planning model to external input including economic data and market data.
Formulate strategies for various lines of business.
Review and revise to formalize strategies.
Publish the strategies for lower level planning in businesses and operating units.

### Bottom-Up Business Planning

The baseline of this bottom up planning can be last year's operating budget, last year's actual business result, or an academic model. This baseline will be updated to show planned number for future year(s), including new business and products, and responding to new policies and strategies.

### Reconciliation and Revision

Both top-down and bottom-up planning may be conducted at the same time period, and involve multiple cycles and revisions. The multiple cycles will include consolidations, reconciliations, reviews and revisions. Final planned numbers may then be treated as budget for the following year.

Features and functions will be included to perform various kinds of processing and calculation This Application facilitates the communications, reviews and revisions, until all parties come to an agreeable plan and budget.

### Lower Level Planning

This refers to more detailed planning for product development, system development, program planning and project planning Based on higher level plan, operational level managers can expand and respond back with detailed planning Rollup of the detailed plan will then be reconciled back to higher level business plan.

### Operational Control

The result from the above processes is then used as the baseline for Operational Control and in-fiscal-year modification. These changes will not ovenide the original plan. Instead, various versions of plan will form historical records, to be analyzed by planners as Knowledge and intelligence for future years.

### Application Design—Systems Development Management

### Design Objectives

This Application is designed to improve the System Development Process. With this Application, System Development Process is Knowledge based and its outcome is also documented as Knowledge. Operations that are based on the designed system will also be Knowledge based, with full audit trail for future reference.

### Baselines for Systems Development

System development should be guided and controlled by many Subject Dimensions including the following:
Strategies and Business Plan
Product Development Plan
Systems Development Plan
Business and Operational Performance Standard
Audit and Control Standard
Quality Management Standard
Risk Management Standard
Project Management Life Cycle Standard
Software Development Life Cycle Standard

Some of the above standards are essential for Systems Development Baseline Knowledge of these standards will be provided based on professional standards. Examples are Project Management Life Cycle and Software Development Life Cycle.

### Scope Definition and Project Planning

If the business scope of the organization is well defined, management selects and includes Knowledge Objects from the Knowledge Library. Otherwise, defining the business scope of the targeting System is the first key factor.

When the scope is clear, a preliminary Project Plan can be defined. Baseline of this plan may involve Business Plan, Product Development Plan, and System Development Plan.

### Analysis and Requirement Specification

This Application may be used to present Scope from the above and formulate Systems Requirements as Knowledge Objects. These Knowledge Objects of Systems Requirements are also linked to related Standards and Plans.

### Knowledge Based System Design

A Systems Designer can examine the Knowledge Objects of Systems Requirements from above and design System Functions to meet those requirements. System Functions are defined as Knowledge Objects that link explicitly to the Requirements directly as Subjects. Design Specification is now Knowledge based and may be linked or traced clearly to meet related Standards and Plans. Traceability is clear between System Content and Business Content, while meeting both quality and performance standards of the corporation.

### Software Engineering and Application Development

This KM System can guide the development of IT systems. Business processes, procedures and rules may be broken down, analyzed, and documented with this KM System. This Application may function as documentation integrator, specification integrator, and application Knowledge integrator. The final result is Knowledge driven IT Applications. Subject space may be defined to guide IT development projects including dimensions of Project Management Life Cycle, Software Development Life Cycle, Audit Requirement, Security, Business Continuity, Management Control etc.

### Change Management

Programs, projects, and systems development etc. are all introducing changes to organizations. This Application allows corporations to gather Knowledge on existing situations, document the design solutions and changes, plan implementations, track post-implementation problems and effectiveness etc., all under the Subject of Change Management and its related standards Change histories are also recorded by default on every component of a system as all Knowledge will be time-stamped and filed by this Application.

### Application Design—Management Information Systems

### Design Objectives

This KM System functions as integrator of all Knowledge in the organization With this integration, all employees in the organization can easily refer back to past Knowledge and to document new Knowledge for future use. However, re-structuring of existing Application Systems may be required in order to achieve a high level of integration with this KM System. Linkages between this KM System and other Applications may be custom developed to suit the software infrastructure of an organization. The following describes various levels of integration.

### Upgrade Existing Databases to Corporate Knowledge Base

This KM System will upgrade the existing databases of an organization to form a Knowledge base of that organization including the following:
Databases have been augmented by Meta-data Systems to form an Information Base. These are now further enhanced by this KM System to form a Knowledge Base.
This KM System will link Subjects and Objects to the related data as entry points to get up-to-date Knowledge on the business.
Create corporate archive by storing up and linking up reports from various data and Information Processing Systems. All reports will be linked to the time-line as a Subject.
Create linkages from this KM System to all other e-documentation in the organization

### Interface with Existing Information Processing Systems

This KM System will provide easy interfacing with existing systems of an organization Examples of interfaces include the following:
From this KM System to information processing systems to get the required Data Knowledge.
From other data and information processing systems to this KM System to get Descriptive Knowledge on how to use the reports and data.
Function as Knowledge storage for parameter driven Application Systems. Parameters are Knowledge data stored as attributes of Knowledge Objects.

### Knowledge Driven IT Application Systems

Business rules stored with this KM System through the software engineering process may be extended to include business operational parameters. Rules and parameters will form a kind of business Knowledge to drive the processing of IT Applications.

Ultimately, IT Systems may also be structured and accessed through the KM System where all operational and managerial responsibilities will be defined. Any employee with the proper authority can perform their roles and responsibilities using the functionalities of the IT Systems.

### Usage of IT Application Functions

System content, from menu items selection to input of transaction data, and retrieval of information, can be grouped and set up as Knowledge Objects. Operational procedures may also be set up as Knowledge Objects. All Knowledge Objects may be grouped and linked together with execution order for both training and business operations.

Execution and usage of IT application functions together with transaction data may also be recorded as Knowledge Objects and filed as audit trails and business records.

When a business transaction is performed, a Knowledge Object may be called and used to execute the transaction. This in turn may call upon other Knowledge Objects. Objects will contain procedures, transaction data, parameters to drive a computing algorithm, triggers to activate processing functions and recording the business transaction.

### Knowledge Driven Data Warehousing

As one kind of IT Systems, this KM System can integrate with Corporate Data Warehouse and various departmental and functional Data Marts. With properly documented explanations about data, information, and how to use those data and information, users can easily understand various data tables, data cubes and their presentation formats, hence improving the usage of data warehouse and data marts. With knowledge subjects defined for corporation, knowledge objects will include various decision models, data entities, data cubes, or even commands to mine the data warehouse.

### Application Design—Business Operation and Control

### Design Objectives

This KM System can support the operations and controls of an organization

### Capture Creativity of Employees

Creativity is a valuable Subject Dimension. It can be linked with other Subjects to encourage input from stakeholders of the organization. The scope of management Knowledge is defined as Subject Space. Corporation Knowledge may be created and managed by individual persons, subject area communities, management and finally as corporate standards

Authors may remain anonymous and yet proprietary until enough interests, attentions, discussions and ideas have been drawn and gathered. Special interest groups may be formed. Formalized proposals can then be prepared and sent to management for decisions and approvals. An organization can provide incentive to original and supplementary authors for ideas and Knowledge once accepted by the organization.

### Business Intelligence Support

This KM System may be used to promote business intelligence in management. Planning and communication can include dimensions of Strategies, Operational Monitoring and Data Warehousing. Segmentation of Market, Product Groups/Lines, and Management Structure etc. may be documented as Subjects with certain level of details. Interfacing may be built that periodically analyzing segment performance. Performance results are recorded in this KM System for management review and decision making.

### Problem Solving Support

This KM System may be used to document, publish and accumulate Knowledge for operational supports. These include Help Desk Support, Customer Service Support and Customer Reference Library.

### Business Continuity Support

This KM System may be used to document, publish and accumulate Knowledge for business continuity supports. These include Disastrous Recovery and Contingency Operations.

### Interface with Office Suites and Report Generators

This KM System provides easy interfacing with outputs from Office Suite Software and Report Generating Software. Typical interfaces include graphics, video clippings, document images and web pages.

### Interface with E-mail System

This KM System provides easy interfacing with e-mail system that needs to retrieve Knowledge. E-mails also create Knowledge such as discussion tracks of various Subjects and Objects. This KM System will function as Knowledge storage for those artifacts used or generated by e-mails.

### Interface with E-Learning System

This KM System provides easy interfacing with e-learning. E-learning System needs to retrieve Knowledge as course contents, illustrations and for skill transfers. Subject dimensions can pin-point the artifacts filed in this KM System.

### Corporate Communications

This KM System allows corporations to set up and enforce standard practices and procedures. These cover business communications, corporate announcements, and human resource management. It may also be used to document internal communication records including videos, voice messages, conference and meeting records etc.

This KM System may be used to gather questions and suggestions from employees, suppliers, business associates or even the public. Its richly implemented Subjects will enable a corporation to efficiently utilize or respond to inputs and to take corrective actions.

### Knowledge Based Conference and Meeting

This KM System allows corporations to formalize conferences and meetings as Knowledge based discussions and resolutions.

Agenda and background information for conferences and meetings may be prepared as Subject Dimensions with linkages to the related Subjects and Objects in this KM System. As conferences and meetings are conducted, the linked Knowledge will be available to all participants to prepare for, and review in the meetings. Discussions and resolutions may also be documented and filed by this KM System for further reviews and executions.

### Better Collaboration and Resource Utilization

With better Knowledge documented for the past and the present, it will be easier to plan the future and to optimize skill utilization. It will also lead to better collaboration in programs, projects and operational processes.

### Application Design—Communication and Stakeholder Relationship

### Design Objectives

This KM System will function as an integration tool for communication among all levels and types of stakeholders. Effective and sincere communication raises the level of tmst and hence improves the relationship among all stakeholders. Separate KM Systems may be set up for Intranet, Extranet, and Internet of the corporation. Communication is extended to include suppliers, customers and the general public.

### Individual Work/Performance Record and Skill Transfer

The Personal Management tools for the public domain may be used by employees to manage their personal work performances and work records. There will also be tools to create Knowledge for skill transfers.

### Personal Knowledge Management for Associates

Personal Knowledge Management tools in the public domain may be used in corporate environment for employees and other stakeholders including even customers. Essentially, this provides means for individuals to access, organize and store up information by their individual perspectives and needs. They can then evaluate the information, and form Knowledge to work with the organization.

### Career Development Programs

This KM System may be used to set up various career development programs in corporations. The tools for learners and researchers in the public domain may also be used by employees for personal and professional developments.

### Knowledge Management for Corporate Portals

This KM System can function as the supplier of Knowledge under various Corporate Portals, directly or through other KM Systems working under the portals. Portal of this category includes many varieties. Examples are business to customers, professional association to members, and public institutes to constituencies etc.

### Knowledge for Suppliers and Alliance Organizations

This KM System may be implemented for customers and the public to access in the web site of corporation Extranet. Knowledge opened to suppliers and business alliances will be stored there. Access control may be implemented by individual identifications.

### Knowledge for Customers and the Public

This KM System may be implemented for customers and the public to access in the Internet web site of the corporation. Sales promotions, customer services, product catalogues, product documentations, user manuals, customer orders, public relations, public reports, news announcements etc. may all be included in this KM System.

### Knowledge Management for Contact and Service Centers

Together with the Corporate Portals, this KM System can function as the supporting software for corporate contact centers and service centers. These centers may record and share their Knowledge and experiences in answering inquiries, solving problems, and providing services for various stakeholders.

### Implementation Design for Hardware and Software

### Hardware Consideration

The overall implementation design objective is to manage Knowledge with a general purpose computer network. All design may be implemented by software alone. Hardware implementation will be for the purpose of faster processing when needed.

In general, capacity of general purpose hardware should be sufficient to meet the need of this KM System even for public domain in Internet world. For corporate environment, this System should be run as part of the corporate systems. A well designed network computing environment should be flexible enough to evolve with hardware evolution and upgrades.

At some particular time, firmware may be employed to speed up processing if desirable but it is not a necessary condition.

Special purpose computer may be deployed when Knowledge Objects include executable software codes for special purpose computers. This will be for longer term implementation including management of robotic knowledge.

### Software Consideration

Software is algorithms and algorithms are combinations of structure and programs/procedures. All structure and programs/procedures described in this document may be implemented with most general purpose programming languages and existing system software including data management software.

When desirable, custom designed data base management software may be developed by the Subject and Object Orientation described in this document. Other procedures may be implemented with most general purpose programming languages.

High level programming language may be developed to speed up programming for procedural composition and execution including linkages among Knowledge Objects. But this is not a necessary condition for this KM System.

Knowledge Objects containing knowledge of intelligent machines must contain software related to the related machines. But this is more on content management of Knowledge Objects instead of software of this KM System.

### Implementation Design for Public Domain Launching

One version of this KM System is to be run in Internet for the Public. This version aims at covering all Knowledge that are of the interest of individuals, including almost all Subjects, academic and general interests. This KM System may be launched as universal entry point for the Knowledge stored in the Internet World.

### Control of Subject Space

Definition of Subject Space and Dimension Names must be controlled although open for public suggestions. Control may be performed by “Subject Editors”, “Subject Librarians”, or other similar position definition.

### Control of Object Content

Part of the Object Content should be written by various authors who will disclose full identity and pick up full responsibilities. This is particularly true for abstraction type of content. However, each Knowledge Object includes an open forum for discussions and suggestions. This KM System will assist users to read various types of content and to determine identity and reliability. Editing tools will be available for appointed Subject Editors.

### Controlled Authoring

Authoring is under the control of this KM System. All authors are registered in the System with personal identification and professional profile, but not privacy information. Published pages have the name of the author to demonstrate freedom of speech, but with author's personal responsibility, verses a forum of rumors and gossips.

### Copyrights and Disclaimer

Owners of various attachments will maintain copyrights. While operators of this public KM System own the copyrights of published Knowledge, there will be no implied liabilities on Knowledge accuracy. It is only a posting facility for authors and the general public.

### Public Authoring

Controlled authoring enhances Knowledge content but at a price of slower development. To compensate for this, this KM System allows input from the public as a draft or partial form of Knowledge authoring. This can be available for Knowledge seekers before the controlled version is published.

### Open Forum

This KM System will provide open forum and open connectivity to various individual web postings outside. Connectivity will be from individual Knowledge Object. In general, all connected Knowledge postings may be evaluated by readers. Linkages will be regularly renewed. Open forum will be classified by types of information including the following: details, illustrations, supportive views, opposite views, discussions, suggestions, questions and answer lists etc.

### User Suggestion and Recommendation

This KM System will provide suggestion boxes for users to propose changes to both the KM System and posted Knowledge. Suggestions will be automatically forwarded to various editors and authors as input to their future maintenance.

### Public Discussion Forums

This KM System will allow special interest group to open up discussion subject and use it to build consensus. This kind of discussion forum, while connect to available Knowledge in the public domain, may remain as confidential within the special interest group until it is ready for publication.

This KM System may also be used as public discussion forum by Subject. Public will be able to review and study the various posted Knowledge. Public can document their opinion in details by the same Subject Structure.

### Access and Usage Statistics

This KM System will monitor access and usage for statistical purpose.

### Reader Evaluation and Opinion Statistics

This KM System will allow readers to input their opinion or evaluation on content. This will provide additional information for users to decide on reliability and meaning of each piece of Knowledge.

### Connectivity to Other Knowledge and Information Providers

This KM System will allow readers to search outside Knowledge and information in the Internet world. A user can use popular Internet search tools to find information related to the name of a particular Knowledge Object, as available in the Internet world, or in special web sites. Additional tools will be provided to filter in only those more related to the related Subjects.

### Multiple Languages

This KM System will include functions and features to handle multiple major languages.

For Knowledge Authoring, the following features will be included:
Author writes on Knowledge in any language.
Author uses translation software to create preliminary version in a different language.
Author forwards software translated version to professional translator for improvement.

For Knowledge Seekers, the following features will be included:
User selects any language from a standard list.
This KM System searches stored Knowledge in the language specified by the user.
When the Knowledge is not stored in the selected language, this KM System will search that Knowledge in other language and translate the content into the selected language.
Users may select one language for retrieval and another language for comparative presentation

### Implementation Design for Corporations and Other Organizations

### Design Principles

A version of this KM System is for business corporations and other organization types, including charitable and public sector. There are three platforms for implementation. One platform is on Internet for customers and public. Another is on Extranet (or other restricted network) for vendors and business alliances. The third one is on Intranet (for other private network) for management and employees.

The design objective is to enhance the efficiency and effectiveness of all stake-holders of the organizations. This is achieved through more Knowledge Objects captured, richly structured Subject Dimensions, and proper positioning of Objects in the Subject Space.

After a Knowledge Base has been well established for a corporation, MIS should then be considered as Management Intelligence System, instead of Management Information System. Corporate Knowledge will be easily accessible. This KM System will function as a support system for business operations. Ultimately, it will be a real Decision Support System.

This KM System allows an organization to implement a Knowledge Library that links with existing information systems. This may be done without reworking any existing systems. Beyond that, existing systems may evolve further to make good use of the Knowledge stored in this KM System.

The design of this KM System may be implemented without changing any existing business practice from strategy to operational procedure. Beyond that, future business management and operations may evolve to make better use of the Knowledge in this KM System.

### Multi-Media Content Management of Corporate Knowledge

This KM System may be used as an integrated and multi-media Content Management of Corporate Knowledge. The following sections describe some of the standard contents in a corporation or other organizations. The main benefits include proper structure of Knowledge, elevated Knowledge usability (as used by organization units, human resources, business processes etc.), effective Knowledge transfer, easier training, better customer support, and other benefits described below. This KM System extracts Tacit Individual Knowledge to form Corporate Implicit Knowledge. It promotes and facilitates Knowledge Sharing through proper documentation, structuring, retrieved and presented.

### From Unstructured to Richly Structured Knowledge

This KM System will include tools to convert existing corporate documentation from unstructured to richly structured Knowledge Standard set of Subject Space may be used as a baseline for the initial conversion. Rich structure will be built gradually by fine-tuning the Subject Structure and re-running the conversion tools. There will be at least 2 stages of structuring: by software, and fine-tuned by Subject Matter Experts. When Knowledge is well structured with the proper Object and Subject Definition, Corporate Taxonomy and Metadata will be ready, leading to effective usage of Corporate Knowledge.

### Ownership and Security Control

As Knowledge is Assets of organizations and businesses, ownership and security control are essential. This KM System will include Ownership and Access Control by job positions and job levels on Subjects, Perspectives and Knowledge Objects. Encryption will also be an option for storage security.

### Archive Knowledge from KM Software Tools

This KM System will function as the storage of Knowledge from KM Software Tools. Middle-ware will be developed to receive and archive the following types of Knowledge collected by KM Software Tools:
Knowledge Abstraction
Knowledge Details
Numerical Knowledge Data
Multi-media Knowledge Artifacts

### Supply Knowledge to Knowledge Based Software

This KM System will function as the supplier of Knowledge to Knowledge Based Software. Middle-ware will be developed to receive inquiries from, and return the following types of Knowledge back to, other KM Software Tools:
Knowledge Abstraction
Knowledge Details
Numerical Knowledge Data
Multi-media Knowledge Artifacts

### Foundation of Corporate Intelligence

With Knowledge Subjects, Objects and Artifacts all stored in this KM System, management can track and analyze corporate intelligent structure including collaboration pattern, process structure and content, service performance, problem resolution, and lesson learned etc.

### Implementation Design for Professional/Vocational Training and Academic Education

This Knowledge Management System will enhance effectiveness and efficiency of training and learning. This new model is a significant enhancement to Self Studying and Distant Learning, leading to education for all. Security controls apply well in this environment to manage access by students and teachers. Privacy and accessing rights will hence be maintained effectively.

### Professional Standards and Academic Perspectives

These are the baselines of all training and education. Subject Space should be established, at least up to a level of definitive details, by professional standards and academic perspectives.

### Theories and Practical Skills

Both theories and practical skills are Knowledge to be incorporated into any training and skill related Perspectives. Practical Experiences will be recorded and shared.

### Training Models and Educational Curricula

The Authoring Tool will be used by educators and teachers to develop their own training programs and course contents. Learners can follow those curricula which may link to a theoretical model, or customized model chosen by the trainers.

### Course Records

Trainers and teachers may set up a Perspective for their courses. Within a course, trainers and teachers may track progress of individual student. Security control will be used to protect privacy of learners and students.

### Learning and Research Records

The PC version of Learning Tools described in previous section will be used by learners and students to organize their learning. Templates will be provided by the trainers/teachers as baselines for training programs, educational courses or research projects. Learners and students may also link their PC Learning Perspectives to the Course Records.

### Linkages and Connections

There will be open forum for students and teachers to link and share their materials and experiences related to learning and teaching.

### Personal Knowledge Management for Students

Personal Knowledge Management tools in the public domain may be used by students in educational environment. The learning models from training providers will link with the personal management models of training receivers. For learning efficiency and effectiveness, the following may be done:
Link training model to personal Subject Space
Link training model with personal multi-media documentation by Subjects
Reconcile personal learning model with related training models
Reconcile personal activities with personal learning model and related training models

### Personal Knowledge Management for Teachers

Personal Knowledge Management tools in the public domain may be used by teachers in educational environment. The learning models from training providers will link with the personal management models of teachers for efficient service delivery. The learning experiences and results of students may also be uploaded to the teacher's model for evaluation and marking.

### Ownership and Security Control

Ownership and security control are essential for educational sector. An educational institute is an organization; hence security control for an organization applies. In addition, there will be security control authority given to individual students and teachers to manage their own Knowledge assets.

### Deployment Design—Financial Viability in the Public Sector

KM System can function in the public domain with self-financing. Focused Marketing is a revenue generator for the suppliers to advertise at the places where potential customers will look into for related Knowledge. This KM System provides mechanisms for advertisers to place advertisements and business promotional information against the related Subject Domain and/or Knowledge Objects. This KM System will also allow authors to publish their Knowledge and receive returns through advertising and promotions placed against their publication. Hosting of this KM web site can earn commission from e-commerce, in selling merchandise, information, or services.

### Front Page Advertising

Space for front-page advertisements is limited. It may include a ribbon of small windows around screen display, and further derivation out of this space. Customization has many options and variations, but should not degrade effective usage of the KM System. Cost charged to advertisers will be based on posting time and/or hit counts under various situations and conditions.

### Directory Posting

This is the low cost method of Focused Marketing. Two kinds of directory will be available from any Knowledge Object and to be selected by readers at Directory entry points.

A. Global
Global Directory is for business organizations that target at the global market. There will be separate directories for major languages used in global businesses, with translation option.

B. Local
Local Directory is for business organizations that target at the local market. Users will access this directory by selecting the geographical areas and languages. Translation option will also be available.

Directory Posting will be self-served advertising. Advertisers may place entries into the business directories of various Knowledge Objects. This KM System will include on-line functions for advertiser to enter multiple key phases to retrieve related Knowledge Objects, and then select from those Knowledge Objects for advertising entries. Payment processing and renewal notices will also be automated. Content of the directories will include texts, photos and short video clips. These are charged by the amount of information stored. As Subject Names are also Knowledge Objects, advertisers may place their directory entries against related Subjects in the same way as above.

Product and service acquirers may access these directories by specifying the Subjects or Objects.

### E-Mail Connection

When desired by an advertiser, customers will be able to send email to the advertiser through this KM System.

### E-Business Services

This KM System will provide linkages to e-Business Services that will process e-business transactions with participating advertisers.

### E-Market Services

This KM System will provide linkages to e-Market Services where public may buy and sell their merchandises. This e-Market will be run with options to go back and forth between the market and related Knowledge for references and computer assisted decision making.

### Tools for Advertisers

This KM system will include Marketing Tools for advertisers and business promoters to connect to various Knowledge Objects and place directory entries against those Objects. Example: enter keywords, select Knowledge Objects and place directory entries.

### Fee Based External Information Libraries

External fee based media and information libraries in Internet may use this KM System in the Public Sector to sell their services. This KM System will allow Knowledge seekers to pay small fees on ad hoc basis to access information in their web sites.

### Payment Processing

This KM System will include or work with Payment Processing Function when it is necessary to include or interface with e-Commerce activities.

### Accounting, Auditing and Statistics

Accounts may be opened by advertisers so that they may place advertisements in a flexible way and in accordance to their business promotional schedule. Advertiser accounting will include budgetary control and schedule control. Advertising fees may be prepaid into the accounts, or settled with credit/debit cards.

This KM System will include access counts and rates for advertisers. Also included are revenue accounting and auditing functions for various stakeholders who have relationship with monetary transactions related to this KM System.

Some Typical Functions are:
An author may, at any time, audit the revenue and statistics related to his/her own web pages, but not those posted by other authors.
Notify authors regarding deposits to their revenue accounts
Keep statistics on various revenue types
Generate various financial and statistical reports
Permit advertisers to inquire on reader statistics

### Segment for Restricted Access

It is feasible to build segments for restricted access in the public domain This may be accomplished by setting up special Subject Domain with access control of various forms. In general, users may need to obtain accessing authority through membership, prescription, or other granting of accessing rights. Authors may use this to obtain user fees in addition to advertising income.

### Segment for Private Knowledge

Similar to e-mail services, this KM System may serve as an Internet application that facilitates personal learning, and provides storage and retrieval of Knowledge Artifacts for individuals. This service will be secured for the owners after registration, may be a free service up to a certain level, and at a charge beyond.

### Segment for Individuals or Organizations

Similar to advertising, individual and organizations may use this Knowledge Data Base to post their own Knowledge for public access. Knowledge posted in here will be under its own name and structure and only delivered to seekers under specific inquiries.

### Licensed Others to Host Sections of Knowledge

When this KM System is established in Internet, it can be used on global basis and in any language. Other parties may be authorized to launch a portion of this KM System. For example, local Knowledge should be best established and maintained by local people.

### Deployment Design—Financial Viability in Organization Sector

The basic software developed for the public domain may be a baseline for organizational usage. Additional tools and baseline Knowledge are included in the package. The following businesses may be developed with this KM System for corporations and other organizations.

### Knowledge Management Software Services

A baseline of this KM software is on Business Management Subject. It contains academic and professional models, licensed to corporations for easy starting in Knowledge Management.

### Knowledge Management Training Programs

As supplement to the launching of this KM System, Knowledge Database for training programs will be provided for, but not limited to, the following:
For CIO—from CIO to CKO (Chief Knowledge Officer)
For executives in general—an orientation training on Knowledge Management
For Knowledge Analysts—Business Knowledge and Knowledge Management

### License Others to Launch or Support this KM System in Corporate Setting

When this KM System is launched in corporate environment, it can be used on global basis and in any language. Other parties may be authorized to launch and support this system. For example, organizations should be best supported by local business consultants or consulting firms.

### Knowledge Management Consulting Services

As supplement to the launching of this KM System in corporation environment, Knowledge database for consulting services will be available for, but not limited to, the following:
Consulting for CIO and CKO
Consulting for Executives and Managers
Consulting for Knowledge Analysts
Consulting for launching KM System
Consulting for customized projects of Knowledge Management Program

These consulting programs will be either centralized or franchised to other local management consulting companies.

### Standardization and Certification for Open Organizations

This KM System may be used to standardize, audit, and document public information for open organizations that may include charitable and public organizations.

Certification authorities or agents may set up Subject Domain to include standards, actual performance, open information, news and records of auditing etc. Public will be able to access all open information through Internet.

### Consultation Agency of Business Area Expertise

Working for the business owners or senior management, business area expertise Knowledge may be portable from one organization to another on a global scale. As more corporations have installed this KM System, their launching experience on business area expertise Knowledge may be sharable and portable among user groups. Conferences may be organized to share the experience and Knowledge. Employment agencies may also be formed for various professions.

### Operate as a Hosting Facility for Proprietary Knowledge

For organizations that operate by a set of proprietary Knowledge, the owners of this KM System may operate a hosting facility to securely store and manage their sets of proprietary Knowledge. Knowledge users of these organizations can then access the Knowledge in these hosting facilities.

### Operate as a Hosting Facility for Academic and Professional Knowledge

A special case of the above is the selling of standards based on academic theories and professional models. Universities, research organizations and professional organizations may make available a standard set of Subjects and Objects, for corporations to use as a baseline for further customization as corporation standards.

### Operate as an Authorization, Certification and Distribution Agent for Business Publishing

Business Area Experts may want to publish their special Knowledge on an area of business. This may be as large and complex as a standard business model of a particular industry, as small as an implementation model of a particular management aspect, or any general business publications.

### Deployment Design—Financial Viability in Education Sector

The basic software developed for the public domain may be a baseline for customization of educational usage, with additional tools and baseline Knowledge included in the package. The following businesses may be developed with this version of KM System.

### Operate as an Qualification Site for Service Providers

For organizations or individuals who provide education or training on a segment of the Knowledge, owners of this KM System can establish a Qualification and Certification Authority. This authority may grant recognition on programs and courses. In addition, qualification of the teachers may also be included in the Knowledge Database, and be available for the scrutiny by the public.

### Operate as a Hosting Facility for Training Programs

For professional qualification organizations and training providers, owner of this KM System can set up and operation hosting facility to provide required training.

### Operate as an Examination and Testing Agent

For distant learning providers, owners of this KM System can establish a franchising authority. This authority may operate examination centers that will authenticate students and oversee examinations at local level, in accordance to the examination requirements of each program and course.

### Operate as a Certification Authority for Learners

For people who manage their learning through this system, one can establish a Qualification and Certification Authority to grant additional certification on overall achievement. This can be based on standards of Knowledge and experiences, identification verification and proper documentation of learning. In addition, learning transcripts and experience resumes may be generated from this Knowledge Base of individuals, and be available for the job markets.

### Operate as an Universal Open University

As high education becomes unacceptably expensive, Internet training should be the solution. Instead of relying on brand names to charge a premium, a real Open University should be available to all who want to learn. A real Open University should be open for both education receivers and providers.

This KM System will be the ultimate solution, being open for all to provide, receive and audit education All detailed information is available on-line. With proper PKI, this KM System will be trustworthy for all. A small charge per user on a large user base should make high level education affordable for all. With combination of practical training, this KM System can cover a very wide scope of both academic education and vocational training.

This Universal Open University needs not replace other universities. Instead, it may provide a platform for other universities to extend their training off-site and on a global scale. This Universal Open University will add facilities and credential for other universities to extend their student base for distant learning.

This Universal Open University may grant degree recognition based on accreditation from various schools and universities at the aggregate level. This may break down the physical barrier of institutions but is in fact providing a global recognition to all teachers, educators, and educational institutes.

### Operate as Free Education System in a Global Scale

This KM System can be used as a delivery vehicle of free elementary and middle level education for all people in all countries, and in all languages. With Internet access, training programs can be conducted in very low cost. Education in one country can be open to all people in the world. The day of free global education is then realized.

### Deployment Design—Administrative Functions

This KM System is designed for two purposes. One purpose is to operate in the public domain of Internet, to be accessed by the public and a unified platform of Knowledge. The other purpose is to be launched in organizational Intranets/extranets, to be assessed by the permitted stakeholders of the organization. The following are some of the required administrative functions:

### Administrative Functions for Public Platform

Administrative functions will include but not limited to the following:
1. Librarian administrative functions.
2. Author administrative functions to control the Subjects and Objects.
3. User administrative functions.
4. Administrative functions for advertisers.
5. E-business functions for advertisers.
6. Business and revenue administrative functions.
7. Control and audit functions for financial integrity of miming a business.
8. Various types of security control functions.

### Administrative Functions for Organizational Platforms

Administrative functions will include but not limited to the following:
1. Training functions for various types of users.
2. Administrative and business operational functions to develop and distribute baseline Knowledge.
3. Security and backup functions for organizations to operate this KM System.
4. Administrative functions to work with management consulting companies.

### Administrative Functions for Educational Platforms

Administrative functions will include but not limited to the following:
1. Functions to operate training programs.
2. Functions for providers and receivers of training programs.
3. Functions for self-learning programs.
4. Functions for distant learning programs.
5. Functions for a global open university.

### Appendix 1—Example of Authoring Procedures

The following describe the initial set of procedures for the Authoring Process. This process, however, shall evolve over time as authors become more familiar with this method of publication.

### From Proposition to Set-Up

1. Author proposes a Perspective to Authoring Committee
2. Authoring Committee reviews and approves the Perspective
3. New Author receives training and Authoring Tool on PC

### Define the Knowledge Structure with Authoring Tool on PC

4. Author defines a Perspective and the related Subjects
5. Author defines a hierarchy of Knowledge
6. Author uploads the Knowledge Structure to the Authoring Server

### Processing by Authoring Server

7. Notes: Authoring Server is the editor and a temporary storage for authors before publishing. For editing and validation, checking will be done on both Production Server and Authoring Server
8. The Authoring Server validates Perspective and related to Subjects.
9. If there is any error, processing will be terminated and the error reported to the Author for correction
10. The above processing will be repeated until all data have been validated.
11. When the Knowledge Structure is valid, then Knowledge Forms will be generated by the Authoring Tool in the Server. If the Knowledge Object is already existing, then the form will contain existing Knowledge
12. Author downloads all the Knowledge Forms to the PC.

### Complete the Knowledge

13. Author completes the Knowledge Forms and make all necessary adjustments
14. Author uploads both the structure and the forms back onto the Authoring Server.

### Final Validation and Publication

15. The Knowledge Server validates the data for the last time.
16. The above procedures will be repeated until all submission by an author is valid.
17. When all the Knowledge entries have been validated, the perspective will be published

### On-Going Maintenance

18. After publication, Author will maintain the Perspective directly on the Production Server.

### Appendix 2 —Example of Learning Procedures

The following describe the initial set of procedures for the Learning Process. This process, however, shall evolve over time as learners become more familiar with this method of learning.

### Learning from Subject Level

1. A Knowledge Learner navigates to the web site.
2. Web site displays some basic functions.
3. Knowledge Learner selects the function to enquire by Subject Name
4. If Subject Name is NOT in the System, Then return the message “Subject is NOT in the platform” Else display a list of all related Perspectives under that Subject in alphabetical sequence.
5. Knowledge Learner selects a Perspective with double-click
6. The System displays the structure of the selected perspective
7. Knowledge Learner select a Knowledge Object with double-click
8. The System displays the content of the selected Knowledge Object.

### Learning from Perspective Level

1. A Knowledge Learner navigates to the web site.
2. Web site displays some basic functions.
3. Knowledge Learner selects the function to enquire by Perspective Name
4. If Perspective Name is NOT in the System, Then return the message “Perspective is NOT in the platform”Else displays the structure of the selected perspective
5. Presentation of the Knowledge Structure is by the selection of the Knowledge Learner with the default of Spreadsheet presentation (also for Phase 1 launching).
6. Knowledge Learner selects a Knowledge Object with double-click
7. The System displays the content of the selected Knowledge Object.

### Learning with Tools

1. A Knowledge Learner navigates to the web site.
2. Web site displays some basic functions.
3. Knowledge Learner selects the function to download learner tools
4. Learner tool downloaded to the PC of learner
5. Learner follows the learner tool to select Subject and perspective for learning
6. Learner follows the learner tool to study the content of selected perspective
7. Learner records study notes and learning experience in learner's PC.

### Appendix 3—Example of Automated Directory Entry Procedures

The following describe the initial set of procedures for the Advertising Process with Directory Entries. This process, however, shall evolve over time as advertisers become more familiar with this method of advertising.

### Directory Entries

Advertiser goes to the web site
Computer displays options for advertiser
Advertiser selects the Subject under which to advertise
Advertiser enters key words for advertising against those words
Computer displays a list of Knowledge with one or multiple of the key words under the selected Subject
Advertiser selects the Knowledge Objects for directory entry
Advertiser may also select option to observe the Knowledge structure for better understanding on how Knowledge seekers may navigate to any particular Knowledge Object
Computer calculates and displays the cost of the total directory entry
Advertiser enters the directory information for advertising and submit payment
Computer confirms the selected direct entry
Advertiser may alter or confirm or cancel the directory entry
When confirmed by advertiser, computer updates directory entries to include the new entry

### Directory Maintenance

Advertiser goes to the web site
Computer displays options for advertiser
Advertiser selects the Subject under which to advertise
Advertiser enters the related entry identification
Computer displays the existing entry
Advertiser changes the information in the directory entry
Directory entries updated to include the new information

### Appendix 4—Examples of Business Training Programs

### Overview Training Program

| Level 1 | Level 2 |
|---|---|
| Session 1 | Course Objectives |
| | Course Content Summary |
| | Introduction and Summary of KM |
| | Understand scope and implications |
| | Technology factors |
| Session 2 to Session N | Knowledge Structure and Maintenance of Policy Formulation and Business |
| | Planning |
| | Knowledge Structure and Maintenance of Product/Service Management |
| | Knowledge Structure and Maintenance of Program/Project Management |
| | Knowledge Structure and Maintenance of Marketing and Sales Force |
| | Management |
| | Knowledge Structure and Maintenance of Finance and Accounting |
| | Knowledge Structure and Maintenance of Operational Control and Auditing |
| | Knowledge Structure and Maintenance of Software Development Cycle |
| | Knowledge Structure and Maintenance of Quality Control and Risk Management |
| Session N + 1 | Human factors and Political Considerations |
| Closing Session | Targeted Platforms |

### Training for Knowledge Analysts

Similar to the above with additional sessions on the following
Details of selected Subjects of Knowledge
Technical Model of Knowledge Management
Political Model of Knowledge Management
Implementation Consideration
Management of KM programs and projects.

### Appendix 5—Examples of High Level Subject Groups & Subjects

### Some Subject Groups and Subjects of Common Interest

Clothing: Fashion
Food: Cooking
Home: Interior Design
Local Interest: Entertainment, Restaurants, Attractions, Shopping Malls, Shops, Transportation

### Some Additional Subject Groups

Agriculture
Bibliography
Education
Fine Arts
Geography
History
Language
Law
Library Science
Literature
Medicine
Music
Philosophy
Political Science
Psychology
Religion
Social Sciences
Science
Technology

### Examples of Subjects under LAW

Administrative Law
Anti-Corruption Law
Art Law
Aviation Law
Banking & Finance Law
Bankruptcy Law
Business Law
Censorship Law
Citizenship & Migration Law
Civil Law
Competition Law
Computer and Cyberspace Law
Constitutional Law
Construction Law
Criminal Law
Defamation Law
Elections Law
Employment Law
Entertainment, Arts & Sport Law
Environment Control Law
Family Law
Foreign Investment Law
Freedom Law
Health & Medicine Law
Human Rights Law
Indigenous Law
Industrial Relations & Labor Law
Inheritance Law
Insolvency & Bankruptcy Law
Insurance Law
Intellectual Property
International Law
Islamic Law
Labor Law
Land Law
Maritime Law
Military Law
Money Laundering Law
Privacy Law
Real Property Law
Refugees & Asylum Law
Regulatory Law
Religion & the Law
Resources Law
Space Law
Taxation, Revenue & Customs Law
Telecommunications
Terrorism
Tort & Personal Injury
Wills & Probate

### Appendix 7—Examples of Subject/Object Structure and Linkages

### Multi-level Subjects

### Level 1

Engineering: [Civil Engineering; Mechanical Engineering; Electrical Engineering; etc.]

### Level 2

Civil Engineering: [Building; Highway; Bridge; etc]

### Level 3

Building: [Building Type; Construction Methods; Construction Materials; Construction Workers; Construction Costs etc.]

### Level 4

Building Type: [Residential, Commercial, Industrial, Mix-use]

Construction Method: [Anchor on Frame; Pastor on Backing; Glue on Backing etc.]

Construction Materials: [Wall Covering; Ceiling Covering; Floor Covering etc.]

Construction Workers: [High Skill, Medium Skill, Low Skill]

### Level 5

Residential: [Single Detached, Multiplex, Apt. Building]

Related Objects: [Drywall, Cement Board, Ceramic Tiles, Glass Tiles]

Drywall should link to Subjects {Anchor on Frame, Wall Covering, Ceiling Covering, Low Skill}

Cement Board should link to Subjects {Anchor on Frame, Glue on Backing, Wall Covering, Medium Skill}

Ceramic Tiles and Glass Tiles should link to Subjects {Glue on Backing, Wall Covering, Ceiling Covering, Floor Covering, High Skill}

### Level 1

Cooking: [Types of Food, Original Style, Personal Preference, Quality, Basic Technique, Chef Skill, . . . ]

### Level 2

Types of Food: [Appetizers, Salad, Soup, Main Course, Dessert]

Original Style: [American, Chinese, Japanese, Korean, Italian, . . . ]

Personal Preference: [Meat, Vegetarian, Organic, Seafood, Spicy, Mild, . . . ]

Quality: [Nutrition, Metabolism, Evaluation, . . . ]

Basic Techniques: [Saute, Grill, Roast, Pan-fry, Stir-fry, Deep-fry, . . . ]

Chef Skill: [Basic, Intermediate, Experienced, Professional, . . . ]

### Level 3

Nutrition: [Low Carbohydrate, High Protein, High Calcium, . . . ]

Metabolism: [Weak, Healthy, Strong, . . . ]

1. The embodiments of a Knowledge Management (KM) System of Computer Application in which exclusive property or privilege claims are described in this patent application and summarized below.
Claim on Subject and Object Structure with the following characteristics or features:
Multi-level and multi-dimensional Subject Space with many-to-many relationships among Subjects,
Categorization of Subjects with specific meaning for each category leading to different knowledge interpretations and usages,
Presentation of Subject Structure in various graphical formats selectable by users.
Positioning of Information Objects in the Subject Space with many-to-many relationships between Subjects and Objects,
Inclusion of Knowledge Objects with information used by humans or machineries, and driving interactions between humans and machineries,
Store precise and concise information as Knowledge Objects, that may be broken down into multiple levels, with multiple components in each level,
Objects may include sub-typing by specialization and/or component parts,
Objects may have Attribute Values of Attribute Types that represent internal Subject Space of similar Objects,
Different Object Types may lead to different interpretations/presentations of Object contents,
Structure Knowledge Objects with various levels of details, to provide high level abstraction or summary that link to lower level details,
Use the described system to store, maintain, and retrieve various types of knowledge in multi-media, and to interact with users in various forms, formats, and languages,
Grow and expand the information encapsulated in Knowledge Objects, through linkages to other information sites.
Claim on Relationship between Subjects and Objects with the following characteristics or features:
Position every Knowledge Object in the Subject Space, by relating Objects to Subjects,
Dual rules, as Object and Subject, of a piece of information represented by a Subject/Object Name that can be a word or a phrase,
The same Name of the above may mean different Knowledge Object, or contain different information when position at a different location of the Subject Space (by relationships with different sets of Subjects),
Data Base Management Software that is based on Subject and Object orientation,
Subjects and Objects together can record intelligence in Decision Models for Decision Support in the future.
Claims on Applications and Usages with the following characteristics or features:
Setup and operate a unified KM System that functions as e-library,
Described machineries and processes that develop, implement, promote, operate and finance a unified KM System in the Internet domain to be used by the general public,
Operate this KM System in organizational setting, for any aspect of management in both the public sector and the private sector,
Use this KM System for professional/vocational training and academic education,
Turn existing tagging into multi-dimensional Subject Structure described in this document,
Convert existing large piece of information into a preliminary version of new and smaller Knowledge Objects and improve on its content, structure and relationships gradually,
Machineries and processes to integrate existing pieces of information and knowledge to form a unified KM System,
Use this KM System as knowledge publication tool for authors, general public, and organizations,
Design of this KM System for editors or librarians to do their jobs in editing both Knowledge Objects Structures and Subject Structures,
Design to document fictional knowledge as a separate Subject, and to write interactive and multi-media novels based on this multi-dimensional KM System,
Building of applications or implied processing functions on this KM System and driven by knowledge captured in the System (some examples are described in this patent application),
Run application software on this KM System by adding training materials, user information, processing menu, date/time scheduling, and procedures, to guide the users through related knowledge,
Use this KM System to perform various business activities including advertising, publishing knowledge, e-business, training and support services.
Note:
This KM System makes no claim to include or rely on any particular existing technology as a necessary condition to implement this KM System. Actually, a good implementation of this KM System should allow proper interfaces to work with any set of selected technologies. This KM System should also be structured in a way so that it can evolve over time and work with future technologies.
